(19) United States
(12) Patent Application Publication
(10) Pub. No.: US 2026/0286622 A1
(43) Pub. Date: Sep. 24, 2026

(54) SMART HYBRID SEALANTS FOR CONCRETE CRACKS AND JOINTS, METHODS OF MAKING, AND METHODS OF USE

(71) Applicant: Board of Supervisors of Louisiana State University and Agricultural and Mechanical College, Baton Rouge, LA (US)

(72) Inventor: Guoqiang Li, Baton Rouge, LA (US)

(21) Appl. No.: 19/163,874

(22) PCT Filed: Mar. 29, 2024
(86) PCT No.: PCT/US2024/022250

§ 371 Date: Sep. 10, 2025

Related U.S. Application Data
(60) Provisional application No. 63/456,609, filed on Apr. 3, 2023.

(51) Int. Cl. E01C 7/14; C04B 41/00; C04B 41/48; C04B 41/63; C09D 7/63; C09D 7/65; C09D 121/00; C09D 125/06; C09D 183/04; E01D 22/00; E01D 101/24; E04G 23/02

(52) U.S. Cl. CPC E01C 7/147; C04B 41/0045; C04B 41/0072; C04B 41/009; C04B 41/4857; C04B 41/4876; C04B 41/488; C04B 41/63; C09D 7/63; C09D 7/65; C09D 121/00; C09D 125/06; C09D 183/04; E01D 22/00; E04G 23/0203; E01D 2101/24

(57) ABSTRACT

The present disclosure provides for concrete joint and crack sealants, methods of using sealants, and kits including the components to form sealants, and the like. In an aspect, the present disclosure provides for concrete joint and crack sealant, where the sealant includes or consists essentially of: a porous expandable skeleton comprising pores; and a filler comprising a two-way shape memory polymer (2W-SMP), wherein the filler fills the pores.

### CROSS-REFERENCE TO RELATED APPLICATIONS

This application claims the benefit of U.S. Provisional Application entitled “SMART HYBRID SEALANTS FOR CONCRETE CRACKS AND JOINTS, METHODS OF MAKING, AND METHODS OF USE” and having Ser. No. 63/456,609, filed Apr. 3, 2023, which is herein incorporated by reference in their entireties.

### STATEMENT REGARDING FEDERALLY SPONSORED RESEARCH

This invention was made whole or in part from funding received under Contract No. 1946231, by the National Science Foundation. The Government has certain rights in the invention.

### BACKGROUND

Existing preformed smart sealants for sealing cracks and joints in cement concrete pavement and bridge decks use an adhesive layer to bond the shape memory sealant stripe to the concrete wall. The adhesive layer, however, may not be able to survive the harsh environments such as extremely low temperature, as well as cyclic traffic load or fatigue load.

### SUMMARY

Aspects of the present disclosure provide for concrete joint and crack sealants, methods of using sealants, and kits including the components to form sealants, and the like.

In an aspect, the present disclosure provides for a concrete joint and crack sealant, the sealant comprising: a porous expandable skeleton comprising pores; and a filler comprising a two-way shape memory polymer (2W-SMP), wherein the filler fills the pores. In an aspect, concrete joint and crack sealant does not include an adhesive.

In an aspect, the present disclosure provides for a concrete joint and crack sealant, the sealant consisting essentially of: a porous expandable skeleton comprising pores; and a filler comprising a two-way shape memory polymer (2W-SMP), wherein the filler fills the pores. In an aspect, concrete joint and crack sealant does not include an adhesive.

In an aspect, the present disclosure provides for a kit for use in filling concrete joints and cracks, comprising: a first component and a second component and instructions for use, wherein the first component is to be positioned within a concrete joint or crack and after placement of the first component in concrete joint or crack, the second component is disposed within the first component, wherein forming a concrete joint and crack sealant upon disposing the second component within the first component, wherein the first component is a porous expandable skeleton comprising pores and the second component is a filler comprising a two-way shape memory polymer (2W-SMP), wherein the filler is used to fill the pores of the porous expandable skeleton. In an aspect, the kit does not include an adhesive.

In an aspect, the present disclosure provides for another kit for use in filling concrete joints and cracks, comprising: a first component and a second component and instructions for use, wherein the second component is disposed within the first component forming a concrete joint and crack sealant wherein the first component (with the second component disposed therein) is to be positioned within a concrete joint or crack, wherein the first component is a porous expandable skeleton comprising pores and the second component is a filler comprising a two-way shape memory polymer (2W-SMP), wherein the filler is used to fill the pores of the porous expandable skeleton. In an aspect, the kit does not include an adhesive.

In an aspect, the present disclosure provides for a method for sealing a concrete joint or crack, comprising: inserting a porous expandable skeleton into the concrete joint or crack; and filling the skeleton with a filler comprising a two-way shape memory polymer (2W-SMP), wherein the combination of the porous expandable skeleton and the filler form a concrete joint and crack sealant. In an aspect, the concrete joint and crack sealant does not include an adhesive.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIGS. 1A-1D illustrate previous polystyrene-based one-way shape memory polymer (1W-SMP) sealants designed and developed in the Li group [1]. FIG. 1A is an illustration of sealant programming, installation, and performance during temperature rising. FIG. 1B shows the biaxial specimen dimensions and von Mises stress distribution. FIG. 1C shows the original (a) and programmed (b) cruciform foam sealant specimen, along with the recovery process under various temperatures (c)-(f). FIG. 1D provides camera images showing the programming setup and testing method of the cruciform foam specimen.

FIG. 2 is a graph of an entire thermomechanical cycle in both tension and compression directions for a 1W-SMP specimen programmed by 25% tensile strain at a temperature above the glass transition temperature, followed by 25% compression at a temperature below the glass transition temperature in the transverse direction, in terms of stress-strain-time scale (T represents tension, C stands for compression, and T&C represents coupled tension and compression) (Note: To have both tension and compression directions in the same quadrant, the compression stress and compression strain are also treated as positive) [6].

FIGS. 3A-3B are camera images of a one-way shape memory polyurethane (PU) sealant installed in a cement concrete pavement at Louisiana State University campus (Engineering Lane), which is a street with commuting buses. FIG. 3A shows the sealant after installation in January 2012, and FIG. 3B shows the same sealant in September 2020.

FIG. 4 graphs a “real world simulation” for cured two-way shape memory polymer (2W-SMP) cis polybutadiene (CPBD) after installation. Simulation of the daily temperature cycle, accompanied by loading and unloading. The two-way shape memory effect (2W-SME) and loading/unloading effect may be coupled [12].

FIG. 5 shows joint type and locations (EJ: expansion joint; CJ: contraction joint); The 2W-SMP smart sealants are indicated in blue (bottom); three types of control sealants are in black (top). Each joint reservoir was sealed by two sealants in the same lane: half lane by control sealant and the other half lane by our smart sealant so that side-by-side comparison can be made.

FIGS. 6A-6I are camera images showing on-site sealant installation at MnROAD (Minnesota's Cold Weather Pavement Testing Facility). (FIG. 6A) A fresh cut expansion joint. (FIG. 6B) Dust blowing from the joint. (FIG. 6C) On-site installation staff from Louisiana Multifunctional Materials Group LLC (LAMG), MnROAD, and D. S. Brown. (FIG. 6D) and (FIG. 6E) 2W-SMP Smart sealant installation. (FIG. 6F) Joints after sealant installation. (FIG. 6G) hot-poured asphalt sealant. (FIG. 6H) liquid silicone rubber sealant. (FIG. 6I) D. S. Brown compression sealed rubber sealant.

FIGS. 7A and 7B are camera images of a joint being cut with a hand-held saw and the resulting non-uniform width cut.

FIGS. 8A-8D show the failure modes of the 2W-SMP sealant and the hot pour asphalt sealant observed on Feb. 12, 2020, in MnROAD for one expansion joint (EJ1) and one contraction joint (CJ1). For the 2W-SMP sealants, they show sign of adhesive failure (debonding the adhesive from the concrete wall); for the asphalt-based sealant, they show both adhesive failure (debonding from concrete wall) and cohesive failure (fracture of the sealant itself). FIG. 8A shows EJ1: 2W-SMP sealant; FIG. 8B shows EJ1a: hot pour asphalt sealant; FIG. 8C shows CJ1: 2W-SMP sealant; FIG. 8D shows CJ1a: hot pour asphalt sealant.

FIG. 9 is a camera image of the 2W-SMP sealant in an expansion joint (EJ2) after over 1,000,000 times of ESAL (equivalent single axle loads, 18,000 lb load) in ALF (Accelerated Loading Facility) in Louisiana. The pavement has been significantly damaged, including pumping and D-cracking. However, the sealant, including the adhesive, are still in good condition.

FIGS. 10A-C illustrates steps to program, install, and form the hybrid sealant in a cement concrete pavement joint in accordance with embodiments of the present disclosure.

FIG. 11 is a schematic illustration of an entire thermomechanical cycle for a 1W-SMP open cell foam in accordance with embodiments of the present disclosure.

FIG. 12A is a camera image of a silicone rubber honeycomb mold used as the porous expandable skeleton; FIG. 12B shows the cellular silicone mold filled in with an uncured 2W-SMP in accordance with embodiments of the present disclosure.

FIG. 13 shows the frequency sweep test result of the uncured 2W-SMP mixture by a rheometer at 25° C. in accordance with embodiments of the present disclosure.

FIG. 14 shows the 2W-SME of the cured 2W-SMP gel sample in accordance with embodiments of the present disclosure.

FIG. 15 is a camera image of the 2W-SMP-silicone hybrid sample under 20% compression within the Xpert 2610 test camber in accordance with embodiments of the present disclosure.

FIG. 16 shows the compressive load change with time as the temperature cycles between −40° C. to 60° C. for a period of 47 hours. The compressive strain was 20% and was maintained constant during the entire test in accordance with embodiments of the present disclosure.

FIG. 17 is a camera image of as-prepared open cell silicone foam in accordance with embodiments of the present disclosure.

FIGS. 18A and 18B are camera images of silicone open cell foam skeleton filled in by the 2W-SMP gel in accordance with embodiments of the present disclosure.

FIG. 19 is a graph showing the compressive load change with time as the temperature cycles between −40° C. to 60° C. for a period of 37 hours. The compressive strain was 40% and maintained constant during the entire test.

FIG. 20 is a camera image of the smart hybrid sealant sample after the 37 hours of freezing and thawing test in accordance with embodiments of the present disclosure.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

The present disclosure provides for sealants for concrete joint and cracks, methods of using sealants, and kits including the components to form sealants.

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, material science, and the like, which are within the skill of the art.

The following examples are put forth so as to provide those of ordinary skill in the art with a complete disclosure and description of how to perform the methods and use the materials and methods disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

As used herein, the following terms have the meanings ascribed to them unless specified otherwise. In this disclosure, “consisting essentially of” or “consists essentially” or the like, when applied to methods and compositions encompassed by the present disclosure refers to compositions like those disclosed herein, but which may contain additional structural groups, composition components or method steps (or analogs or derivatives thereof as discussed above). Such additional structural groups, composition components or method steps, etc., however, do not materially affect the basic and novel characteristic(s) of the compositions or methods, compared to those of the corresponding compositions or methods disclosed herein. “Consisting essentially of” or “consists essentially” or the like, when applied to methods and compositions encompassed by the present disclosure have the meaning ascribed in U.S. Patent law and the term is open-ended, allowing for the presence of more than that which is recited so long as basic or novel characteristics of that which is recited is not changed by the presence of more than that which is recited, but excludes prior art embodiments. When the phrase “consisting essentially of” is used in regard to concrete joint and crack sealant, this means that components in the concrete joint and crack sealant do not include an adhesive.

### Definitions

One-way shape memory polymers (1W-SMP) as described herein are shape memory polymers that have one permanent and/or native shape and a deformed shape or temporary shape. In these 1W-SMPs, temperature change alone does not drive the recovered shape back to the temporary shape. Accordingly, if a one-way SMP is not programmed after shape recovery, it retains the same shape above or below its glass transition temperature (T_{g}) or melting temperature (Tₘ). A one-way SMP has a single native form whether it is compression-programmed or tension-programmed.

Two-way shape memory polymers (2W-SMPs) as described herein can exhibit programmable and reversible shape switching between the permanent shape and temporary shape as temperature changes. Two-way shape memory polymers change their shape upon stimulation. Many semicrystalline SMPs have demonstrated two-way shape changing effect (2W-SME). During cooling under a constant tensile stress, crystallites form in the loading direction, leading to elongation, accordingly there is expansion as the material is cooled. Additionally, when heated to a temperature above the melting transition of the polymer, the polymer contracts as a result of shape recovery. Thus, a two-way SMP has a larger size or shape at a “low” temperature and a smaller size or shape at a “high” temperature; where “low” and “high” are specified in relation to the other. In the present description a two-way SMP can be used any time a tension-programmed SMP is set forth unless the context clearly indicates otherwise.

Hot-pour 2W-SMPs as described herein are those in the liquid form at high temperature (above the T_{g} of the 1W-SMP skeleton) and can serve two purposes: one is to trigger the shape recovery of the 1W-SMP skeleton, and the other is to cure in situ. They can include such as polybutadiene, polycaprolactone, silicone rubber, and poly(ethylene-vinyl acetate), and their blends or composites.

Cold-pour 2W-SMPs as described herein are those in liquid form at low temperature (below the T_{g} of the 1W-SMP skeleton), which can be poured in the skeleton and cured at low temperature or by light, and can include such as polybutadiene, polycaprolactone, silicone rubber, poly(ethylene-vinyl acetate) or others that can be tailored to cure by ultraviolet light or visible light by adding photoinitiators.

Binder as used herein is a material or composite material that produces or promotes adhesion in loosely assembled substances or acts adhesively. The binding material is generally conventional, and generally can be liquid. Examples of suitable binders used in pavement available in the art include hot-pour asphalt, cold-pour asphalt emulsions or solvent diluted asphalt or rubber latex such as silicone rubber, acrylic latex, natural rubber, styrene-butadiene rubber, polyurethane, or rubber modified asphalt emulsion.

“Glass transition temperature (T_{g})” as used herein describes the temperature at which amorphous polymers undergo a transition from a rubbery solid (T>T_{g}), to a brittle, glassy amorphous solid (T<T_{g}). This rubbery-to-glassy transition (or glass transition for short) is a reversible transition. The glass transition temperature T_{g} is always lower than the melting temperature, Tₘ, of the crystalline state of the material, if one exists. Despite the massive change in the physical properties of a material through its glass transition, the transition is not itself a phase transition (a phase transition does occur at the melting point (Tₘ), defined below); rather glass transition is a phenomenon extending over a range of temperatures and is defined by one of several conventions. Several definitions of T_{g} are endorsed as accepted scientific standards. Nevertheless, all definitions are arbitrary, and they often yield different numeric results: at best, the defined values of T_{g} for a given substance typically agree within a few Kelvin. Common synonyms for Glass transition temperature (T_{g}) include shape memory transition temperature (Tₜᵣₐₙₛ).

“Melting point (Tₘ)”: as applied to polymers as used herein, refers to a transition from a solid crystalline (or semi-crystalline) phase to a viscose amorphous liquid phase. The phenomenon is more properly called the crystalline melting temperature. Among synthetic polymers, crystalline melting is only discussed with regards to thermoplastics, as thermosetting polymers decompose at high temperatures rather than melt. Consequently, thermoset polymers do not melt and thus have no Tₘ. The Tₘ is what triggers the change between the two native forms of a semicrystalline two-way SMP.

Type IV sealant as used herein refers to a low modulus sealant according to specifications in ASTM D6690, suitable for geographic regions that regularly experience negative degree temperatures.

### General Discussion

Generally, cracks or joints in concrete paving (e.g., roadways, pavements, walls) are filled with a sealant. The sealant protects the joint from cracking or chipping on the exposed edges of the joint, which can cause concrete failure. In some cases, asphalt is used as a sealant. In other cases, the sealant is a flexible liquid sealant or an expandable material that is held in place with an adhesive. However, extremes in temperature can cause additional expansion or contraction of the joint and adhesive failure, leading to the sealant becoming dislodged from the joint. This problem is so pervasive that the colloquial term “black snake” has been coined to describe dislodged compression sealed rubber sealants spotted on roadways. Failed sealants contribute to road damage, causing the need for frequent and expensive closures and repairs.

In accordance with the purpose(s) of the present disclosure, as embodied and broadly described herein, embodiments of the present disclosure, in some aspects, relate to adhesive-free smart sealants for concrete joint and cracks (also referred to as “joint and crack sealant”). Aspects of the present disclosure provide for concrete joint and crack sealants, methods of using sealants, and kits including the components to form sealants, and the like.

The present disclosure provides for a concrete joint and crack sealant. The sealant can include or consist essentially of a porous expandable skeleton comprising pores and a filler. The filled can include a two-way shape memory polymer (2W-SMP). The filler and the porous expandable skeleton do not include an adhesive. The filler can be used to fill the pores. In an aspect, concrete joint and crack sealant does not include an adhesive.

In addition, the present disclosure provides for a kit for use in filling concrete joints and cracks. The kit can include a first component and a second component, as well as instructions for use (e.g., as described here and also in view of the method of use description). The first component is to be positioned within a concrete joint or crack and after placement of the first component in concrete joint or crack, the second component is disposed within the first component. A concrete joint and crack sealant is formed upon disposing the second component within the first component. Alternatively, the second component can be disposed within the first component and then it is placed in the concrete joint or crack. The first component is a porous expandable skeleton comprising pores and the second component is a filler comprising a two-way shape memory polymer (2W-SMP). The filler is used to fill the pores of the porous expandable skeleton. In an aspect, the kit, the first component and the second component do not include an adhesive.

The present disclosure also provides for a method for sealing a concrete joint or crack. The method can include inserting a porous expandable skeleton into the concrete joint or crack and filling the skeleton with a filler comprising a two-way shape memory polymer (2W-SMP). The combination of the porous expandable skeleton and the filler form a concrete joint and crack sealant. In an aspect, the concrete joint and crack sealant does not include an adhesive.

Now having described aspects of the present disclosure in general, additional aspects are now described. Embodiments of the present disclosure provide for methods of designing, manufacturing, and installing smart sealants, compositions including a skeleton made of compression programmed 1W-SMP or compressed porous rubber or hollow rubber, where pores of the skeleton are filled in by 2W-SMP. Here, the porous 1W-SMP or porous rubber or porous elastomer or porous semicrystalline polymer is termed as a skeleton, which serves as a framework or load bearing structure to support the fillers to be filled in the pores. In addition, the present disclosure provides for products including a skeleton made of 1W-SMPs that have a T_{g} higher than the temperature encountered in the summer in the pavement, or rubbers or elastomers or semicrystalline polymers that are in rubbery state even in the lowest pavement temperature to be encountered in the winter, which is filled in with any 2W-SMPs or 2W-SMP based composites that can actuate reversibly within the highest temperature and lowest temperature range that will be experienced in the pavement.

The present disclosure includes a 1W-SMP or rubber or elastomer or semicrystalline polymer skeleton that is filled in with a 2W-SMP or 2W-SMP based composite. Advantageously, the sealants described herein can be tuned to perform well in geographical areas with wide temperature swings as well as regions that have extreme temperatures and weather (e.g., extreme sub-freezing snow zones or hot summer desert areas).

Embodiments of the present disclosure include a smart sealant as above, wherein the skeleton can be compression programmed 1W-SMP or compressed porous rubber or elastomer or semicrystalline polymer, and a filler, where the filler can be a 2W-SMP or 2W-SMP based composite that can be hot-poured or cold-poured into the skeleton.

Both one-way shape memory polymer (1W-SMP) and two-way shape memory polymer (2W-SMP) solid stripes have been studied as smart sealants in cement concrete pavement, which are installed by bonding the smart stripe to the concrete wall using an adhesive. Adhesive failure (debonding of the adhesive layer from the concrete wall) has been identified as a critical failure mode for this type of smart sealants, especially in cold regions.

The present disclosure provides hybrid smart sealants formed by hot- or cold-pouring a material including 2W-SMP into pores (e.g., interconnected pores, where about 10%, about 20%, about 30%, about 40%, about 50%, about 60%, about 70% about 80% or about 90% or more of the pores are directly or indirectly interconnected) of an expandable skeleton (e.g., the skeleton of the compression programmed 1W-SMP or compressed porous or hollow rubber or elastomer or semicrystalline polymer). The expandable skeleton can be formed from such as compressed cellular rubber or elastomer or semicrystalline polymer (e.g., natural rubber or silicone rubber, styrene-butadiene-styrene elastomer, polybutadiene semicrystalline polymer), compression-programmed open cell 1W-SMP foam, cellular 1W-SMP, or 3D printed 1W-SMP mechanical metamaterials. Advantageously, the smart sealant described herein is adhesive-free and can be used in both hot and cold regions. To be economical, in cold regions, the 2W-SMP is selected based on its expansion characteristics, while in hot regions the 2W-SMP is selected based on contractile characteristics.

The compressed skeleton can be placed into the joint or crack reservoir. Therefore, for 1W-SMP based skeleton, the cross-section of the skeleton after compression programming should be inserted into the reservoir without difficulty. For porous or hollow rubber, elastomer, and semicrystalline polymer skeletons, they should be compressed by over 10%, 20%, 30%, 40%, 50%, 60%, 70%, 80%, and 90% and then inserted into the reservoir without difficulty. After installation of the skeleton, the pore size should be large enough to allow penetration of the hot-pour or cold-pour 2W-SMP or 2W-SMP composite, which can be determined according to the equations in the later sections.

The hybrid 2W-SMP sealants described herein are adhesive-free, thereby eliminating adhesive failure common in current 1W-SMP and 2W-SMP sealants. The hybrid sealant includes an expandable skeleton, which can be formed from porous, flexible materials having interconnected pores. The expandable skeleton is impregnated with a 2W-SMP material that fills the interconnected pores.

The 2W-SMP material can be a 2W-SMP-based composite (such as 2W-SMP-modified asphalt or a 2W-SMP diluted with a plasticizer).

In an aspect where the expandable skeleton is formed from cellular rubber, the skeleton can be pre-filled in with 2W-SMP and can be compressed and pushed into the joint reservoir or crack in situ.

In an aspect where the expandable skeleton is formed from compression programmed open cell 1W-SMP foam skeleton or cellular 1W-SMP, it behaves as a compression-sealed sealant by triggering the shape memory effect of the compression programmed 1W-SMP skeleton in situ by hot-pouring/extruding the 2W-SMP into the interconnected pores in the 1W-SMP skeleton or by direct heating the skeleton first before pouring/extruding the 2W-SMP or 2W-SMP based composite into the interconnected pores. In other words, the skeleton applies tension programming to the 2W-SMP.

Advantageously, because the sealant has a two-way shape memory effect (2W-SME), it prevents water infiltration into the pores of the expandable skeleton and will also work collaboratively with expandable skeleton in the winter and in the summer through its 2W-SME, i.e., expansion when temperature drops and contraction when temperature rises.

In embodiments, the 1W-SMP can be a thermoset foam, thermoplastic foam, rubber foam, semicrystalline polymer foam, or elastomer foam. The 1W-SMP can include, for example, epoxy, polyurethane, polystyrene, bisphenol A glycerolate dimethacrylate, polytetrafluoroethylene, vinyl ester, polylactide, poly(ethylene-vinyl acetate), poly(p-dioxanone), polyimide, poly(vinyl butyral), silicone rubber, styrene-butadiene-styrene elastomer, polybutadiene, and so on, or a combination thereof.

In embodiments, the skeleton can be a rubber or elastomer or semicrystalline polymer. The rubber or elastomer or semicrystalline polymer can include e.g., silicone rubber, natural rubber, styrene-butadiene-styrene, styrene-butadiene, acrylic, high-saturated nitrile, epichlorohydrin, ethylene propylene diene, polybutadiene, poly(ethylene-vinyl acetate), polyurethane, and poly(ε-caprolactone).

In embodiments, the 2W-SMP can be a thermoplastic polymer, thermoset polymer, rubber polymer, elastomer polymer, semicrystalline polymer, organic gel polymer, liquid crystal gel polymer, or an asphalt modified by one or more than one of these 2W-SMPs. The 2W-SMP can be cured thermally or by ultraviolet light or visible light. The 2W-SMP can include cis poly(1,4-butadiene) (PBD), Poly(ε-caprolactone) (PCL), poly(cyclohexyl methacrylate) (PCHMA), poly(ε-caprolactone)-dimethacrylates (PCLDMA), poly(ethylene glycol) monomethyl ether-monomethacrylate (PEGMA), styrene-butadiene-styrene (SBS), poly(ε-pentadecalactone) (PPDL), poly(ethylene-vinyl acetate) (PEVA), silicone rubber, and combinations thereof.

In some embodiments, the 2W-SMP can be combined with a plasticizer to form a softer 2W-SMP. In some embodiments, the soft 2W-SMP can have a higher ratio of plasticizer than 2W-SMP. For example, the ratio of plasticizer to SMP can be about 90:10 by weight (w/w), about 85:15, about 80:20, about 75:25, about 70:30, about 65:45; about 60:40; about 55:45, or about 50:50, or about 40:60, or about 30:70, or about 20:80, or about 10:90. In some embodiments, the plasticizer can be a sebacate, a glutarate, an adipate, an azelate, and a phthalate. Other plasticizers can be used as can be appreciated by one of ordinary skill in the art.

In some embodiments, other materials such as hardeners, catalysts, or photoinitiators can be added to the 2W-SMP to tune the material for desired properties. Hardeners can include e.g., dicumyl peroxide, benzoyl peroxide, and lauroyl peroxide.

As described above, the porous expandable skeleton can be formed from a 1W-SMP or a rubber or an elastomer or a semicrystalline polymer, where the skeleton has interconnected pores. The interconnected pores can refer to pores that are irregularly spaced and/or sized, extending from the outside of the skeleton toward the inside of the skeleton. Such irregular pores are formed when the skeleton is an open cell foam. Alternatively, if the skeleton is a rubber or other materials that do not form pores naturally during formation, the pores can be formed from a mold (see example 2 below). Additionally, the skeleton can be manufactured by 3D printing.

A 2W-SMP or 2W-SMP based composite (such as 2W-SMP modified asphalt) as described above is added as a filler into the interconnected pores of the 1W-SMP skeleton or rubber or elastomer or semicrystalline polymer skeleton. The 2W-SMP or 2W-SMP based composite fills the center aperture of the skeleton when the skeleton is a hollow tube stripe.

When the skeleton comprises 1W-SMP, the open-cell 1W-SMP foam stripe or hollow tube stripe will be compression programmed in the thickness (width of the joint or crack) direction before installation. The compression programmed 1W-SMP foam or hollow tube stripe will have equal or slightly smaller width than the width or opening of the crack or joint so that the programmed stripe can be manually inserted into the crack or joint with ease. Alternatively, where the porous expandable skeleton is a rubber or an elastomer or a semicrystalline polymer, there is no need for compression programming prior to installation.

The programmed 1W-SMP skeleton can be triggered for shape recovery in situ either by hot pouring 2W-SMP or 2W-SMP based composite into the interconnected pores, or by direct heating the 1W-SMP skeleton before cold pouring 2W-SMP or 2W-SMP based composite into the interconnected pores.

In various embodiments, the porous expandable skeleton can be a hollow tube having a cross-sectional shape such as circular, square, rectangular, ovoid, triangular, tear-drop, accordion-folded, etc. as can be appreciated by one of ordinary skill in the art.

The 1W-SMP can be selected according to the environment in which it will be used. In a preferred embodiment, the transition temperature (glass transition temperature or melting temperature) of the 1W-SMP open cell foam or hollow tube is at least 20° C. higher (e.g., about 20 to 50° C., about 20 to 40° C., about 20 to 30° C.) than the highest temperature that will be encountered in the outdoor environment and storage environment.

In various embodiments, the recovery stress of the 1W-SMP open cell foam or hollow tube is determined by equaling the pulling force to the resistance force, where the pulling force is the force exerted by traffic pulling the sealant from the joint and where the depth and width of the joint are considered, along with the contact area with the concrete. (see Equation (3) in the examples).

In various embodiments, the required compression programming strain can be determined by Equation (11). In a particular example, to meet the needs for Type 4 sealant (for use in cold regions), the recovery strain should be greater than 200% as measured from the fixed shape.

In various embodiments, the porosity of the 1W-SMP skeleton before compression programming can be about 10% to 90% (e.g., about 10%-30%, about 30%-50%, about 50%-55%, about 55-60%, about 60-65%, about 50-70%, and about 70-90%). The porosity of a rubber or elastomer or semicrystalline polymer skeleton can be about 10% to 90% (e.g., about 10%-30%, about 30%-50%, about 50%-55%, about 55-60%, about 60-65%, about 50-70%, or about 70-90%).

In various embodiments, the pore size of the 1W-SMP after compression programming can be about 1 μm and 1 mm, to allow permeation of the hot-pour or cold-pour 2W-SMP or 2W-SMP based composite into the interconnected pores by gravity or through pressurized extrusion.

In various embodiments, the 1W-SMP hollow tube wall thickness and the porosity meet with strength and actuation requirements based on the forces applied to the sealant, change of temperature, the detailed structures of the skeleton and the pores, and the boundary conditions. Finite element analysis is used to calculate the stress and strain based on the strength of the materials to determine the thickness of the tube or skeleton.

In various embodiments, the pressure to extrude liquid 2W-SMP or 2W-SMP based composite into the interconnected pores in the compression programmed 1W-SMP skeleton can be determined by Equation (17).

For hot-pour 2W-SMP, the pouring temperature must be higher than the transition temperature of the compression programmed 1W-SMP foam, in order to trigger the shape recovery of the 1W-SMP skeleton in situ.

Rubber elasticity based 2W-SMPs are governed by the E=3 nkT, where E is the modulus of elasticity, n is the number of network subchains per unit volume of the rubber or crosslink density, k is Boltzmann constant, and T is the absolute temperature. Their glass transition temperature should be lower than the lowest temperature that will be encountered in the pavement to keep the rubber in a rubbery state.

For those 2W-SMPs that are based on both rubber elasticity and melt/crystallization transition, the crystallization temperature should be such that the 2W-SMP should exhibit 2W-SME up to the lowest temperature that the pavement will experience.

Advantageously, the 1W-SMP open cell foam or hollow tube and 2W-SMP filler can be tuned to satisfy sufficient stability, durability, and fatigue life under environmental attacks and traffic load, as required by relevant ASTM standards for sealants.

In various embodiments, the expansion upon cooling (EUC) and contraction upon heating (CUH) of the 2W-SMP or 2W-SMP based composite filler match the maximum expansion and maximum contraction of the 1W-SMP that will be experienced as a sealant.

As mentioned above, conventional open-cell rubber foams or cellular rubbers or hollow rubber tubes can be used in lieu of a 1W-SMP for the skeleton. These types of materials, including elastomers, semicrystalline polymers, organic gels, and thermoplastic polymers, can be compressed in-situ in order to be inserted into the joint/crack reservoir.

In various embodiments, the open-cell rubber foam has a glass transition temperature at least 30° C. below the lowest temperature that will be experienced by the pavement, while its decomposition temperature should be at least 100° C. above the highest temperature that will be encountered in pavement. Some SMPs are inappropriate because they decompose at low temperatures. The rubber is selected based on the climate needs of the particular environment in which it will be installed, including humidity and UV radiation.

In various embodiments, the level of compression in situ is equal to and larger than the maximum opening that the joint/crack will experience. In a particular example, to meet the needs for a Type 4 sealant, the recovery strain should be greater than 200% based on the installed width.

Although the examples provided herein are related to joint sealants in roadways and bridge decks, the sealants can be used in any concrete joint including but not limited to walls, walkways, runways, building foundations, and the like. The sealants can be used in intentional joints, or can be used to fill cracks that appear after concrete installation, such as in repair work.

The composition, and methods of making and installing the hybrid smart sealant are discussed in detail in this disclosure.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

Previous studies using 1W-SMPs and 2W-SMPs as sealant are discussed for context, followed by descriptions of the composition, method of making, and installation of the hybrid sealant according to the present disclosure. In the following discussion, the terms “open cell foam,” “foam,” and “cellular material” can refer to 1W-SMP porous expandable skeletons or cellular rubber or other skeletons. Although Example 3 focuses on using an 1W-SMP as the skeleton, the discussion is also applicable to cellular rubber or porous elastomer or porous semicrystalline polymer. Throughout, open cell foam or cellular material refers to any material consisting of interconnected pores.

### Example 1—Previous Studies of Using SMPs as Sealant

### 1W-SMP as Sealant

In our previous studies, we have described the working principle of using one-way shape memory polymer (1W-SMP) as sealant, through programming in two orthogonal directions [1]. In this idea, a 1W-SMP based syntactic foam is programmed in two perpendicular directions: compression in horizontal or traffic direction, and tension in vertical direction. In the summer, when the pavement temperature exceeds the glass transition temperature of the foam, shape recovery of the foam is triggered, leading to contraction in the vertical direction, thereby avoiding the problem of sealant squeezing out of the reservoir; in the horizontal direction, the foam also recovers but expands. At the same time, the neighboring concrete slabs expand, too. As a result, the foam will be further compressed in the horizonal direction, instead of expansion. This stored compression will be utilized in the winter. When temperature drops in the winter, the highly compressed foam expands in the horizontal direction when the neighboring concrete slabs contract or retreat. Consequently, even in the winter, the foam remains in close contact with the concrete slabs, avoiding adhesive failure problems at low temperature, similar to a compression-sealed joint.

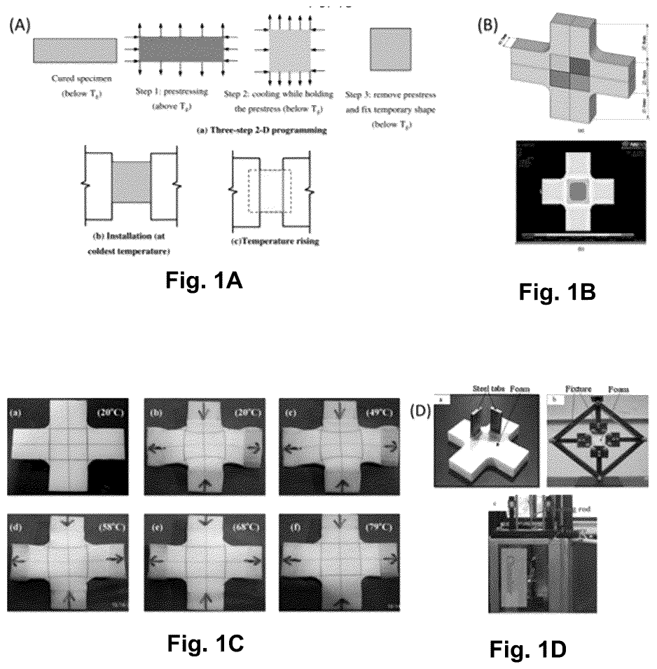

FIG. 1A schematically shows 1W-SMP functionality, FIG. 1B shows the crossform specimen for bi-directional programming, FIG. 1D shows the test assembly and test apparatus, and FIG. 1C shows the bi-directionally programmed specimen in the recovery process from (b) (at room temperature) up to (f) (at 79° C.), leading to complete shape recovery (the shape in (f) is fully returned to the original shape in (a)) [1]. This concept has been validated by both lab-scale experimentation and field-level installation. In lab-scale experimentation, the negative Poisson's ratio effect for the bi-directionally programmed foam was observed [2], the cyclic stress-strain behavior of polystyrene-based shape memory syntactic foam sealant programmed by the 2-D stress condition through a crossform device was tested [3], the effect of ultraviolet radiation on the morphology and thermomechanical properties was evaluated [4], and the durability under accelerated hydrolytic aging was tested [5]. The results show that the 1W-SMP based syntactic foam performs as expected and is durable.

The sealant used is a SMP-based syntactic foam with a polystyrene SMP by Cornerstone® as the matrix dispersed with 40% by volume hollow glass beads by Q-Cel®.

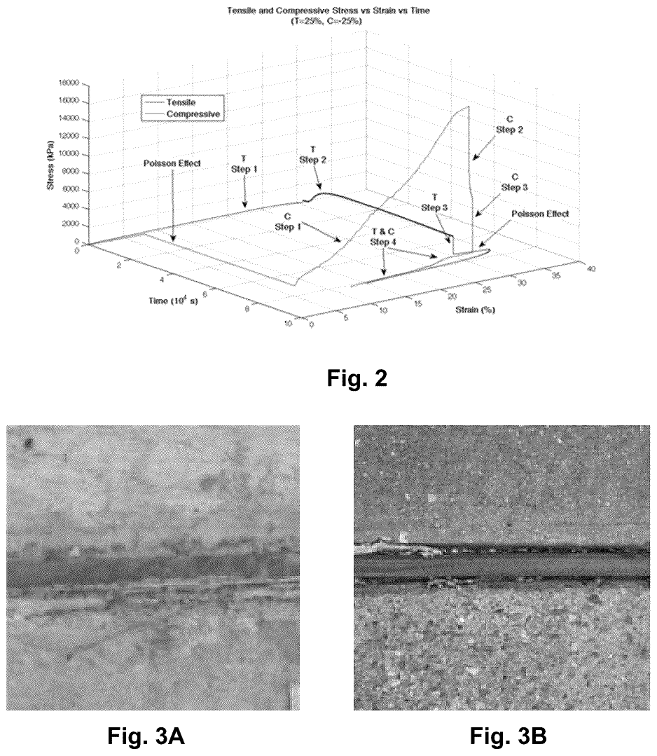

In field-level applications, large 1W-SMP panels need to be programmed (compression in horizontal or traffic direction and tension in the vertical direction) in order to solve the debonding problem at low temperature and sealant squeezing-out of the reservoir problem in the summer. Thus, a two-stage hybrid 1D programming was conducted, i.e., hot tension programming in vertical direction first, followed by cold compression programming in horizontal direction, which proved to be able to replace the one-stage bi-directional programming [6]. FIG. 2 shows the stress-strain-time relationship of the sealant in the entire thermomechanical cycle (programming and free shape recovery) [6]. In field level installations, the inventor's lab selected two expansion joints in a cement concrete pavement at Louisiana State University campus (Engineering Lane), which is a road for heavy bus traffic. We used the two-stage hybrid programming approach and used shape memory polyurethane (PU) as sealant [7]. The two pieces of sealant were installed in January 2012 [7]. After over nine years of service, the two joints are still in good condition; see FIG. 3. From FIG. 3, one can see that while the abrasion of the concrete slab is significant, the PU sealant stripe is still in good condition. However, the loss of the adhesive layer is clear.

While the field-level test of the above 1W-SMP is successful in the hot environment in Louisiana, it may face challenges in cold region. The reason is that the amount of compression programming in the horizontal direction is limited to 50%; otherwise, permanent damage within the foam such as crushing of the glass microballoons (hollow spheres) will occur and unrecoverable plastic deformation may happen, limiting the opening of the crack or joint that can be sealed. If pure 1W-SMP is used, the amount of compression programming is smaller than 50% in order not to damage the 1W-SMP. Another limitation is that an adhesive is needed to glue the sealant stripe to the concrete wall, and over the years premature adhesive layer fail occurs. For the same reason, the 1W-SMP sealant cannot be made into an adhesive-free compression sealed joint because the compression programming strain needed for such type of joint is much higher than 50%, in order to deal with crack/joint opening in the winter.

### 2W-SMP as Sealant

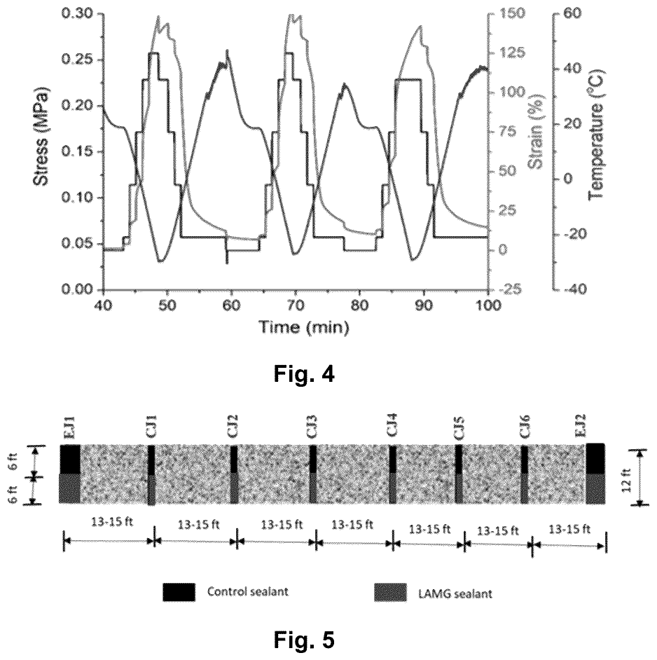

Another recent development in smart sealants is to use two-way shape memory polymers (2W-SMPs) as sealants. As compared to 1W-SMPs, where new programming is required after each shape recovery, 2W-SMPs can reversibly shift between the original and temporary shapes, without the need for subsequent programming. For semi-crystalline 2W-SMPs, the driving force for the two-way shape memory effect (2W-SMEs) is due to rubbery elasticity at temperatures above the crystallization temperature and melt/crystallization transition at temperatures lower than the crystallization temperature [8]. It is noted that a lot of rubbers and elastomers and gels can demonstrate 2W-SME at temperatures above their glass transition temperature if they are under tensile stress, again, due to the rubbery elasticity (modulus reduces as temperature drops and modulus increases as temperature rises) [8]. With a proper initial tensile programming or under a tensile stress but without the initial tensile programming, 2W-SMPs can behave thermally opposite to common physics, i.e., expansion upon cooling and contraction upon heating. Because of this unique behavior, Li proposed that 2W-SMPs can be used as sealants [9, 10]. Lu et al. have investigated two 2W-SMPs that have the potential to serve as sealants: one was Polycaprolactone (PCL) based syntactic foam [11] and the other was chemically crosslinked cis Polybutadiene (CPBD) or CPBD modified asphalt [12]. The advantage of using 2W-SMP as sealant versus 1W-SMP as sealant is that 2W-SMP sealant may not need programming before installation. The daily temperature drop in the field may provide the tensile stress necessary for programming the 2W-SMP and endowing the 2W-SME. To prove this idea, Lu et al. simulated the daily temperature cycle without programming the 2W-SMP (CPBD) [12]. With cooling, they gradually added tensile stress to the specimen to simulate the contraction of the neighboring concrete slabs, and with heating, they gradually removed the applied load to simulate the expansion of the neighboring concrete slabs. As shown in FIG. 4, the temperature drop (blue line) induced a step increase in stress on the sealant (black line), and the strain reached ~150%. Temperature rise led to the expansion of the concrete slabs, and tensile stress on the sealant was gradually reduced, resulting in contraction of the sealant. At the completion of each cooling/heating cycle, the stress became zero and the strain also became zero. While the thermal cycle accompanied by loading and unloading cannot be directly regarded as 2W-SME, because loading will cause extension and unloading will cause shortening, it is believed that the deformation is primarily due to 2W-SME. This is because the small tensile stress (0.25 MPa) applied to the 2W-SMP with a modulus of several hundreds of MPa at freezing temperature can only produce a tiny expansion strain, instead of the over 100% expansion shown in FIG. 4. Therefore, it is believed that the 2W-SMP has a good potential to be used as sealant. To further validate this idea, field level installation and test were also conducted for the CPBD based sealant.

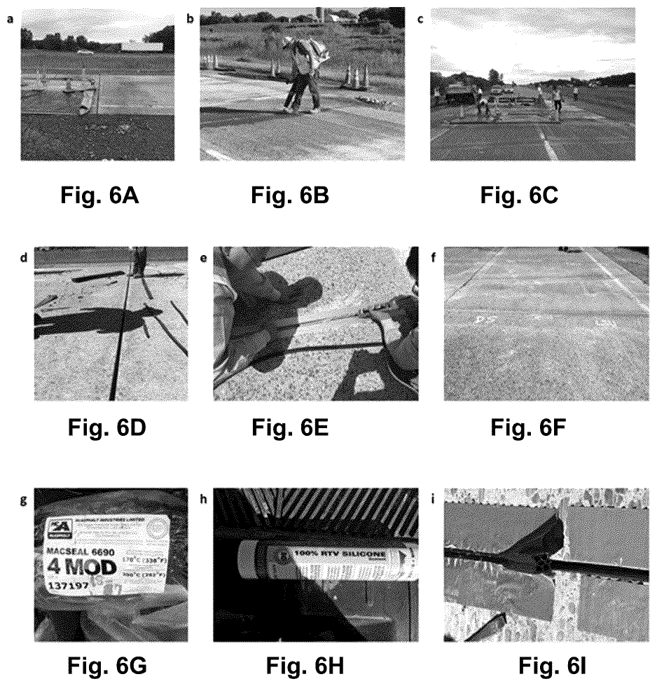

To further validate the idea of using 2W-SMP as sealant, we selected CPBD-modified asphalt. The composition as measured by weight ratio is PBD/asphalt=40/60, which is cured at 150° C. for 1.5 h by using 3 wt % Dicumyl Peroxide (DCP). The dynamic mechanical analysis shows that the sealant has ~40% elongation upon cooling (EUC) and contraction upon heating (CUH) within −50° C. to 50° C. temperature range. The sealant also has good fatigue resistance at low temperature of −35° C., good durability under rain/saltwater attack, and good mechanical properties at 50° C. (Tensile strength: 0.40 MPa, ultimate tensile strain: 257%), room temperature (Tensile strength: 0.65 MPa, ultimate tensile strain: 494%), and at −40° C. (Tensile strength: 8.0 MPa, ultimate tensile strain: 504%). We installed 8 stripes on I-35 in Minnesota on Jun. 26, 2019, following the plan in FIG. 5. This is a two-mile long testbed in parallel with I-35. When testing, the real traffic in one-direction (Minnesota to Montana) is diverted to the testbed; and when collecting data, the traffic is diverted back to I-35. Usually, each month the testbed is subjected to three weeks of traffic and one week for data collection. During our installation, the traffic was diverted to I-35. As shown in FIG. 5, a total of 8 joints were prepared, including 2 expansion joints (EJs) and 6 contraction joints (CJs). The test matrix is given in Table 1. An example expansion joint after saw cut is shown in FIG. 6A. The joints were then cleaned with a backpack blower (FIG. 6B). For the expansion joints, a type of sawdust plywood was used as the backing plate. Because of occasional rain during cutting, black plastic covers were used to keep the joints dry (FIG. 6C). Loctite® PL Premium Max was used to glue the smart sealant strips onto the concrete (FIGS. 6D and 6E). Other than our sealant, one from D. S. Brown Company (compression sealed rubber sealant; see FIG. 6F), one liquid silicone rubber, and one type IV hot-pour rubberized asphalt sealant were installed side-by-side at the testbed. FIG. 6G shows the hot-poured asphalt sealant, FIG. 6H shows the silicone rubber sealant, and FIG. 6I shows the installation of the D. S. Brown compression sealed preformed rubber stripe sealant.

TABLE 1
Test matrix for MnROAD test.

| | Sealant stripe | Joint width | Sealant stripe | Joint |
|---|---|---|---|---|
| Joint name | width (mm) | (mm) | depth (mm) | depth (mm) |
| EJ1 | 19 | 24 | 38 | 40 |
| EJ2 | 19 | 20 | 19 | 25 |
| CJ1 | 6 | 7.5 | 6 | 8 |
| CJ2 | 6 | 7.5 | 12 | 14 |
| CJ3 | 6 | 7.5 | 6 | 8 |
| CJ4 | 6 | 7.5 | 12 | 14 |
| CJ5 | 6 | 7.5 | 6 | 8 |
| CJ6 | 6 | 7.5 | 12 | 14 |

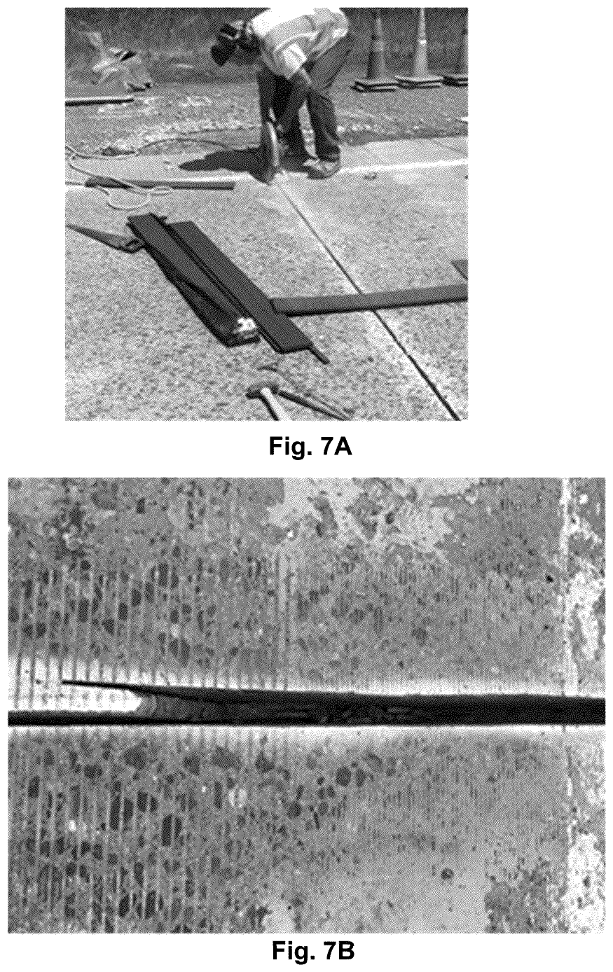

One problem we encountered during the field test installation was that the joint reservoir depth and width did not meet with our designed dimensions. Table 2 summarizes the designed reservoir width and depth in MnROAD testbed and the three actual width and depth measurements for each joint reservoir. Obviously, the joint is wavy and the width of some of the joints is wider than our design (for example, 6 mm wider in EJ2), suggesting thicker glues have to be used because our 2W-SMP sealant width has been fixed after manufacturing and cannot be changed on job site. The reason is that it is difficult to control the hand-held saw to the accurate cut designed; see FIG. 7. The thicker adhesive or glue may be a potential problem, particularly in winter because the glue does not have two-way shape memory effect, i.e., expansion upon cooling. Also, adhesive in the form of thin film usually has higher mechanical strength than that in the form of thicker film [13,14].

TABLE 2
Designed reservoir width and depth and the actual width and depth

| | Designed | | Designed | |
|---|---|---|---|---|
| | reservoir | | reservoir | |
| Joint | width | Actual reservoir | depth | Actual reservoir |
| name | (mm) | width (mm) | (mm) | depth (mm) |
| EJ1 | 24 | 21.64, 20.35, 17.38 | 40 | 40 |
| EJ2 | 20 | 26.00, 26.18, 23.37 | 25 | 25 |
| CJ1 | 7.5 | 9.39, 8.35, 8.53 | 8 | 11.6, 11.62, 10.39 |
| CJ2 | 7.5 | 8.4, 8.52, 8.06 | 14 | 15.11, 15.0, 15.95 |
| CJ3 | 7.5 | 8.21, 7.20, 7.84 | 8 | 10.56, 12.39, 11.18 |
| CJ4 | 7.5 | 8.51, 9.49, 8.6 | 14 | 15.86, 15.86, 16.05 |
| CJ5 | 7.5 | 7.3, 7.84, 7.33 | 8 | 12.41, 12.72, 11.96 |
| CJ6 | 7.5 | 8.52, 9.62, 8.56 | 14 | 15.84, 15.50, 15.89 |

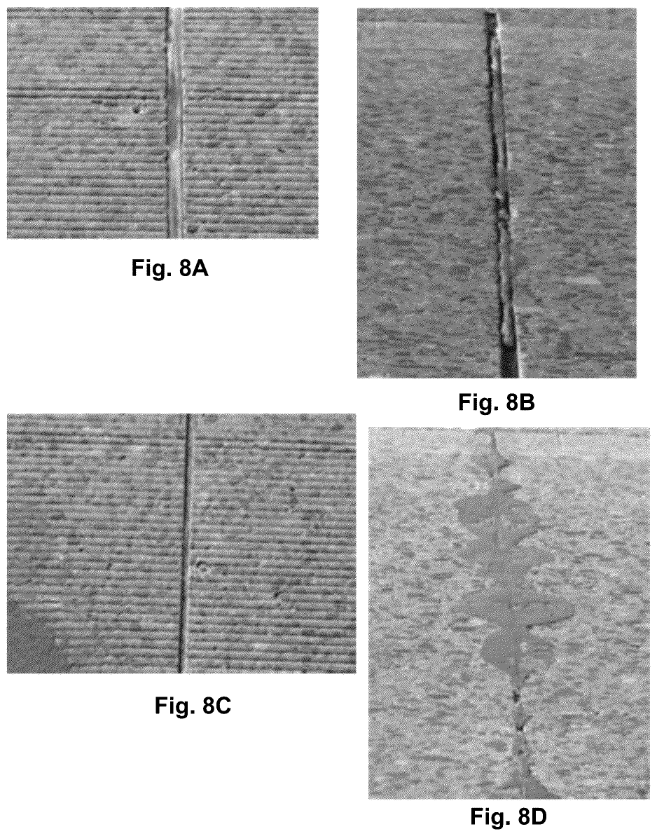

In April 2020, MnROAD provided an interim report on the sealant performance. For the four types of sealants installed, the silicone rubber sealant and the compression sealed rubber sealant are still in good condition. The hot-pour Type IV asphalt-based sealant failed severely. For our 2W-SMP sealant, it seems that the sealant itself is in good condition (no sign of any failure). However, as expected, the thick adhesive used during installation did not survive the extremely low temperature and the heavy traffic load, and all the adhesive failed. FIGS. 8A-8D shows the failure modes of the asphalt-based sealant and the 2W-SMP sealant observed on Feb. 12, 2020, in MnROAD for one expansion joint (EJ1) and one contraction joint (CJ1). It is clear that, for both types of sealants, adhesive failure (debonding from concrete wall) occurred. For hot pour asphalt sealant (FIGS. 8B and 8D, showing EJ1a and CJ1a, respectively), cohesive failure also occurred, meaning that the sealant crumbled. However, the 2W-SMP sealant (8A and 8C, showing EJ1 and CJ1, respectively) did not have any sign of cohesive failure.

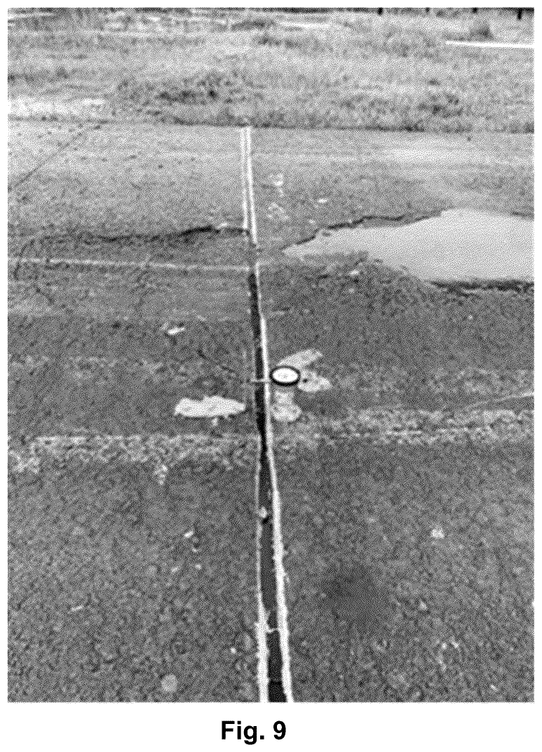

It is noted that we also installed 18 pieces of sealant in the accelerated loading facility (ALF) at Louisiana Transportation Research Center (LTRC) testbed. The sealants were installed on May 25, 2019, and they have been under repeated loading (over 5,650,000 times of equivalent single axle load (ESAL)). As shown in FIG. 9, while the pavement has been significantly damaged, the sealant for expansion joint is still in good condition, suggesting that, in a hot region like Louisiana, the 2W-SMP sealant, just like the 1W-SMP sealant, is successful.

Therefore, the lab-scale testing of the 2W-SMP sealant shows a good potential to serve as sealant in concrete pavement, which is also validated in hot regions. Similar to the 1W-SMP sealant, a challenge is that an adhesive must be used to bond the 2W-SMP sealant stripe to the concrete wall. At extremely low temperatures and under cyclic traffic loading, the adhesive may debond from the concrete wall or from the sealant stripe, resulting in adhesive failure of the adhesive layer and premature failure of the joint (like those installed in MnROAD). Hence, developing new sealant compositions and methods of making and installing the sealant, which will be adhesive-free, is highly desired.

### Example 2

### Composition and Method of Making and Installing the Hybrid Smart Sealant

Described here are new compositions and methods to utilize the advantages of both 2W-SMP combined with a porous expandable skeleton (e.g., 1W-SMP, cellular or hollow rubber stripes, cellular or hollow elastomer stripes, cellular or hollow semicrystalline polymer stripes) as a sealant. Using both materials at the same time makes the sealant adhesive-free, avoiding the disadvantages of adhesive failure while providing lasting performance across a variety of climates and temperature ranges.

For ease of presentation, we will use 1W-SMP open cell foam as an example for the porous expandable skeleton. The discussion also applies to general cellular polymers including cellular rubbers. The idea is that we will first compression program an open cell 1W-SMP foam along the thickness direction (along the horizontal direction when it is installed in pavement). Due to the large porosity, this type of foam can be compressed to well above the 50% strain allowed for syntactic foam. Therefore, when it recovers, it can expand hundreds of percent, and thus will apply a compressive force to the concrete wall due to the constraint by the concrete slabs, forming a compression sealed joint. For compression sealed joints, there is no need for adhesive. Because of its large expansion when triggered for shape recovery, it can work with wider joint/cracks, and colder temperature. Of course, the open cell or interconnected pores cannot stop water infiltration, and this is why open cell foam alone cannot be, and has never been, used as sealant in outdoor pavement. To solve this problem, and also to provide a way of triggering of the shape memory effect in situ (during installation), we will at the construction site hot-pour or extrude 2W-SMP or 2W-SMP composites (such as 2W-SMP modified asphalt) into the compression-programmed 1W-SMP open cell foam. The high temperature will trigger the expansion of the foam in situ and allow filling in the interconnected pores by the molten 2W-SMP or 2W-SMP-based composite, thereby solving the in situ triggering problem. The molten 2W-SMP within the pores, after solidifying, will stop water infiltration and work collaboratively with the 1W-SMP foam skeleton as a sealant. For those 2W-SMPs and 2W-SMP composites that can be cold poured (e.g., 2W-SMP emulsion or solution or gel, or water- or air-cured 2W-SMPs, or ultraviolet cured 2W-SMPs), the 1W-SMP skeleton can be recovered first by direct heating within the joint reservoir, followed by cold pouring of the 2W-SMP filler. Advantageously, if instead a cellular rubber or elastomer or semicrystalline polymer or hollow rubber or elastomer or semicrystalline polymer tube is used to replace the 1W-SMP skeleton, the porous material can be compressed in situ and be pushed into the joint reservoir or crack. The cellular material can be filled in with 2W-SMP before installation, or after installation. The 2W-SMP can be thermally cured for example by a heating gun, or UV cured such as by natural sunlight or by a UV lamp.

The working principles for the hybrid smart sealant are as follows. When temperature drops after installation, the neighboring concrete slabs contract, the compressive stress built in the porous expandable skeleton is reduced, and thus the porous expandable skeleton tends to expand. This expansion will apply a small tensile stress to the 2W-SMP fillers within the pores. For most 2W-SMPs or 2W-SMP based composites, tensile stress and temperature drop are two ingredients for 2W-SMP to exhibit 2W-SME, i.e., to expand upon cooling. Therefore, when temperature drops, both the 1W-SMP foam skeleton and the 2W-SMP filler within the pores expand, i.e., work collaboratively with positive composite action. As a result, not only the water infiltration problem, but also the adhesive failure problem can be solved because it is adhesive-free. Another aspect to consider is when the skeleton expands to maximum or recovers its original shape, the external compressive stress becomes zero. For other sealants, for example, hollow rubber tubes, further expansion is impossible, which leads to dislodge of the sealant from the concrete wall, and the sealant may be sucked out of the reservoir by the moving traffic, meaning a total failure of the sealant. On the other hand, for this new smart sealant, when the skeleton fully recovers its original shape, the 2W-SMP filled in the skeleton continues expansion due to 2W-SME. As a result, the smart sealant maintains tight contact with the concrete wall, suggesting successful sealant. When temperature rises, the neighboring concrete slabs expand, which will compress the 1W-SMP foam skeleton. Due to the shape memory effect of the 2W-SMP fillers within the pores, the 2W-SMP filler will contract and, again, work collaboratively with the skeleton, avoiding excessive compressive stress building up in the sealant, and helping the hybrid sealant work properly. It is noted that during the heating branch, the 1W-SMP skeleton is clod compression programmed [15,16], i.e., compression programming at temperature below the glass transition temperature, and thus the sealant is ready for the second temperature cycles.

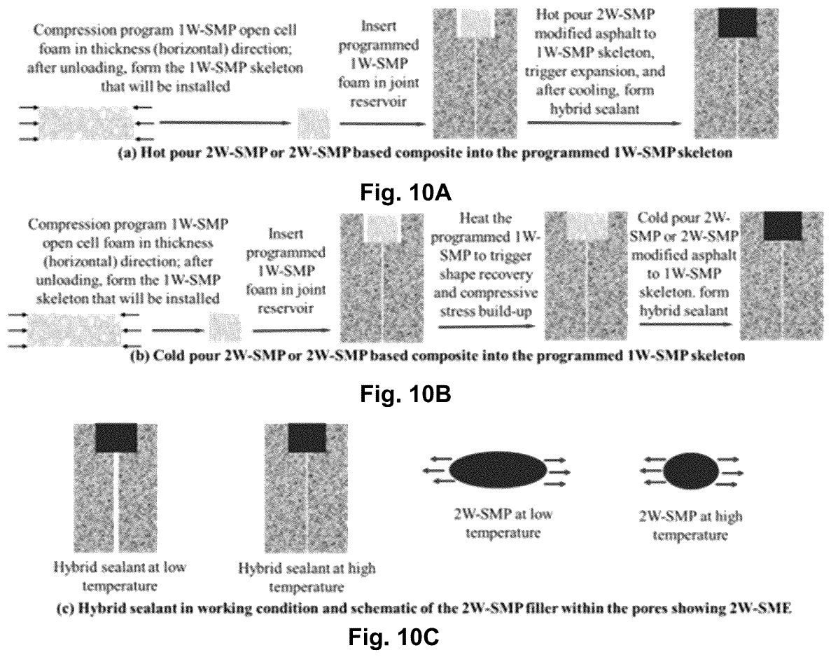

FIGS. 10A and 10B show the steps of the hybrid sealant preparation, installation, and usage. Here the porous expandable skeleton is a compression programmed 1W-SMP open cell foam, but other porous expandable skeletons such as porous rubber as described above can be used without the compression programming step. Method (a) (FIG. 10A): Hot pour 2W-SMP or 2W-SMP-based composite into the compression programmed 1W-SMP skeleton, which includes: compression programming the 1W-SMP open cell foam in the thickness (horizontal or traffic) direction; inserting the programmed 1W-SMP skeleton in the joint reservoir (the thickness of the programmed 1W-SMP foam skeleton is slightly narrower than the width of the joint, to ease inserting); hot pouring 2W-SMP or 2W-SMP-based composite (such as 2W-SMP modified asphalt) into the interconnected pores of the programmed foam, which triggers the 1W-SMP foam expansion (shape recovery of the 1W-SMP skeleton) in the horizontal direction, eliminates the small gap left, builds up compressive stress within the foam skeleton, and finally forms the hybrid sealant after cooling down to service temperature.

As an alternative to Method (a), Method (b) (FIG. 10B): Cold pour 2W-SMP or 2W-SMP based composite into the compression programmed 1W-SMP skeleton, which includes: Compression programming the 1W-SMP open cell foam in the thickness (horizontal or traffic) direction; inserting the programmed 1W-SMP skeleton in the joint reservoir (the thickness of the programmed 1W-SMP foam skeleton is slightly narrower than the width of the joint, to ease inserting) to form a sealant skeleton; heating the inserted 1W-SMP skeleton directly to trigger shape recovery, thereby closing the small gap between the programmed 1W-SMP stripe and the concrete wall and build-up compressive stress within the 1W-SMP skeleton; cold-pour the 2W-SMP or 2W-SMP based composite filler into the recovered 1W-SMP skeleton, and finally form the hybrid sealant.

FIG. 10C shows a schematic of the hybrid sealant working at both low and high temperatures. At low temperature, the 1W-SMP skeleton expands, assisted by the expansion of the filled 2W-SMP due to 2W-SME; at high temperature, the expansion of the neighboring concrete slabs compresses the 1W-SMP skeleton, assisted by contraction of the filled 2W-SMP, again, due to the 2W-SME. The 1W-SMP skeleton always applies a small tensile stress to the filled 2W-SMP, fulfilling the requirement for triggering 2W-SME for most 2W-SMPs. It is noted that some 2W-SMPs do not need the small tensile stress to exhibit 2W-SME, and some 2W-SMPs can exhibit 2W-SME (expansion upon cooling and contraction upon heating) even under compressive stress [8,12].

### Estimation of the Preferred Recovery Stress for the Compression Programmed 1W-SMP Open Cell Foam

For a successful compression sealed joint, the sealant should be constantly under compression in the entire working temperature range. The recovered compressive stress from the 1W-SMP skeleton, even in the winter, which is the lowest in temperature, should resist sealant stripe sucking out of the reservoir by the vacuum produced due to the moving traffic, which can be estimated by the pulling force. The pulling force P can be calculated hv

$$P = p w t \qquad ( 1 )$$

where p=0.1 MPa is the pulling pressure by vacuum; w is the joint width, and t is the widest expected tire width to be used on a roadway.

The resistance force, F, due to friction between the 1W-SMP skeleton and the concrete wall can be calculated by:

$$F = R μ tdc \qquad ( 2 )$$

where R is the recovery stress, u is the coefficient of friction, t is the tire width, dis the sealant depth, and c is the percentage of contact area between the 1W-SMP skeleton and the concrete wall.

By equaling the pulling force to the resistance force (P=F), we have:

$$R = \frac{p}{μ Kc} \qquad ( 3 )$$

where, K=d/w is the sealant shape factor. For example, assuming μ=0.5, K=2, and c=80%, we can find the required recovery stress is R=0.125 MPa, which can be achieved by 1W-SMP open cell foam such as epoxy foam [17].

Evidence shows that this level of recovery stress can be realistically achieved. First, based on the yield strength for porous materials [18]:

$${σ}_{p} / {σ}_{y} ∝ {( p / {ρ}_{s} )}^{n} \qquad ( 4 )$$

where ρ is the density of the foam, ρₛ is the density of the cell-wall material (solid), σₚ is the plastic collapse stress of the foam (cell wall yields), oy is the yield strength of the cell-wall material (solid), and n is the scaling factor. Based on the literature, n=1.5~3, depending on if the cell is closed or open [18]. Let's assume that this equation is valid for estimating the recovery stress of the 1W-SMP open cell foam (a cellular material), and let's also assume the worst-case scenario, n=3, and the density ratio is 0.4 (60% porosity). Based on the recovery stress of an epoxy (17 MPa) [19], we can estimate that, when this epoxy is made into an open cell foam, its recovery stress will be 17 (MPa) (0.4)³=1.09 MPa, which is much higher than what is required. This estimation can also be supported by another recent study. Li et al. synthesized an ultraviolet curing epoxy and used it to print various lattice structures (a type of open cell foam or cellular structure) [20]. The test results show that, when the solid epoxy produces 13.2 MPa recovery stress, the 3D printed lattice structure produces a recovery stress of 3.4 MPa. Other means can also be used to enhance the recovery stress such as adding particles or microfibers to reinforce the 1W-SMP open cell foam. It is noted that this estimation about the required recovery stress is on the safe side because the 2W-SMP filler will have some bond with the concrete wall, and the sealant stripe not directly under the vacuum produced by the moving traffic can also provide pulling resistance due to friction and partial bonding. If assuming that the length of the section without under vacuum is ten times of the length of the section under vacuum, and the partial bonding between the sealant and concrete wall increases the coefficient of friction from μ=0.5 to μ=1.0, the recovery stress needed can be further reduced, which is R=0.125 MPa/10/2=0.00625 MPa. This required compressive stress can be easily achieved by many 1W-SMPs and cellular polymers.

### Estimation of the Compression Programming Strain for the 1W-SMP Open Cell Foam

The minimum compression programming strain depends on the shape fixity ratio, shape recovery ratio, and the required recovery strain. The recovery strain depends on the type of sealing required. For example, in extremely cold regions, Type IV sealant should be used, which should expand a minimum of 200%; in moderate environment, Type 2 sealant should be used, which should expand a minimum of 50% when temperature drops. The following rationale is used to decide the minimum compression programming strain that is needed for the 1W-SMP open cell foam to serve as the sealant skeleton.

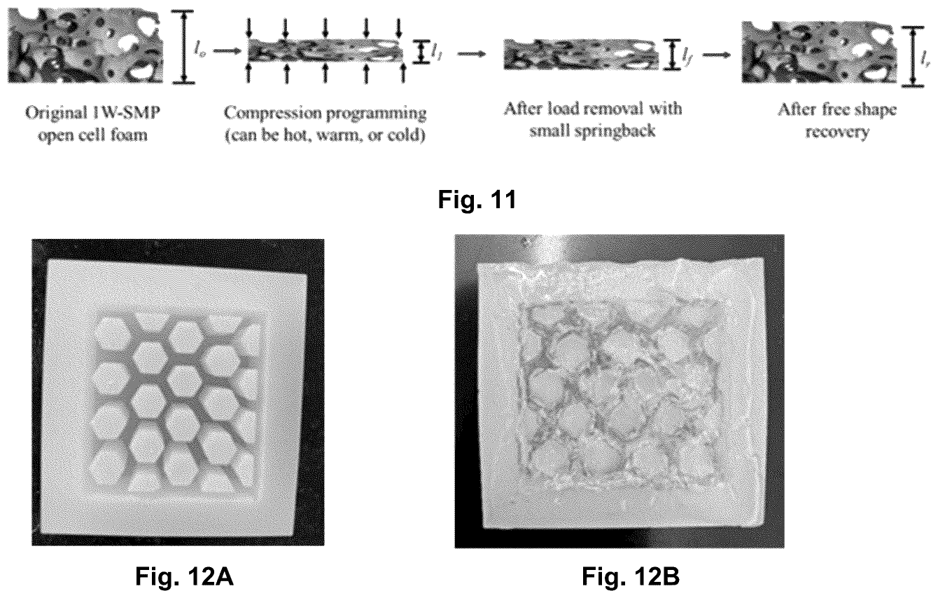

FIG. 11 shows the various stages during programming and free shape recovery of a 1W-SMP open cell foam compression programmed in the thickness direction. Based on this schematic, we can define several strains, as well as shape fixity ratio and shape recovery ratio:

$${ε}_{p} = \frac{{l}_{o} - {l}_{1}}{{l}_{o}} \qquad ( 5 )$$

$${ε}_{f} = \frac{{l}_{o} - {l}_{f}}{{l}_{o}} \qquad ( 6 )$$

$${ε}_{r} = \frac{{l}_{r} - {l}_{f}}{{l}_{f}} \qquad ( 7 )$$

$${ε}_{R} = \frac{{l}_{o} - {l}_{r}}{{l}_{o}} \qquad ( 8 )$$

$$f = \frac{{ε}_{f}}{{ε}_{p}} = \frac{{l}_{o} - {l}_{f}}{{l}_{o} - {l}_{1}} \qquad ( 9 )$$

$$r = \frac{{ε}_{f} - {ε}_{R}}{{ε}_{P}} = \frac{{l}_{r} - {l}_{f}}{{l}_{o} - {l}_{1}} \qquad ( 10 )$$

where ε_{P}, ε_{f}, εᵣ. and ε^{R} are the programming strain, fixed strain after programming, recovery strain as measured from the programmed state, and residual strain after free shape recovery, respectively. fand rare the shape fixity ratio and shape recovery ratio, respectively. For a given 1W-SMP, f and r can be treated as constants.

Through a lengthy formulation process, the following relationship is obtained:

$${ε}_{p} = \frac{{ε}_{r}}{( 1 + \frac{f}{r} {ε}_{r} ) r} \qquad ( 11 )$$

From Eq. (11), if the shape fixity ratio and shape recovery ratio of the 1W-SMP open cell form is known, we can calculate the compression programming strain required to achieve the designed recovery strain. For example, assuming a 1W-SMP open cell foam has f=0.95 and r=0.90, in order for the foam to have a free recovery strain of εᵣ=200%, the compression programming strain should be ε_{P}=71%, which is quite possible for a lot of open cell foams under uniaxial compression. As discussed in the 1W-SMP section above, the maximum compression programming strain allowed for 1W-SMP based syntactic foam (usually by incorporating 50% by volume of hollow particles into the 1W-SMP matrix) is 50%; otherwise, the hollow microspheres will be crushed [21,22]. Although incorporating larger volume fraction of hollow particles, for example 70% by volume, has been tested, the syntactic shows much decreased mechanical and shape memory properties [23]. Based on Eq. (11), and again assuming f=0.95 and r=0.90, and ε_{P}=50%, we find that εᵣ=85.7%, which is far less than the required recovery strain for Type 4 sealant in cold region (εᵣ=200%). Therefore, 1W-SMP syntactic foam or solid 1W-SMP is unsuitable for use as a sealant in cold regions without using a proper adhesive.

Estimation of the Permeability of the Compression Programmed 1W-SMP Open Cell Foam, and the Pressure Needed to Pour 2W-SMP into the Interconnected Pores

After the compression programming, the sizes of the interconnected pores of the porous expandable skeleton are reduced. Accordingly, we investigated whether the reduced pore size would be able to allow flow of the hot- or cold-pour 2W-SMP within the interconnected pores. Several models have been developed over the years to correlate the pore size, liquid properties, and compressive strain with permeability. For example, Dawson et al. proposed the following relationship:

$$\frac{{k}_{T}}{{k}_{o}} ≅ ( 1 + ε ) for 0 ≪ ε ≪ {ε}_{e l}^{*} \qquad ( 12 )$$

$$\frac{{k}_{T}}{{k}_{o}} ≅ \frac{{( 1 + {ε}_{d} )}^{2 a} ( 1 + {ε}_{e l}^{*} )}{{{δ}_{e l}^{*} ( 1 + {ε}_{d} )}^{2 a} + {δ}_{d} ( 1 + {ε}_{e l}^{*} )} for {ε}_{e l}^{*} ≪ ε ≪ {ε}_{d} \qquad ( 13 )$$

where, kₒ is the permeability at 0% strain, k_{T} is the permeability at compression strain

$$ε , {ε}_{e l}^{*}$$

is the elastic buckling strain of the struts, which is usually 7.5% for polymeric foam, and ε_{d} is the strain of the collapsed cells in the densified bands and is assumed to be uniform and called as the densified strain. The corresponding volume fractions of the cells remaining in the linear elastic regime

$${δ}_{e l}^{*}$$

and the densified regime δ_{d}, after the onset of cell buckling, are given by:

$${δ}_{e l}^{*} = \frac{( {ε}_{d} - ε ) ( 1 - {ε}_{e l}^{*} )}{( 1 - ε ) ( {ε}_{d} - {ε}_{e l}^{*} )} for {ε}_{e l}^{*} ≪ ε ≪ {ε}_{d} \qquad ( 14 )$$

$${δ}_{d} = \frac{( ε - {ε}_{e l}^{*} ) ( 1 - {ε}_{d} )}{( 1 - ε ) ( {ε}_{d} - {ε}_{e l}^{*} )} for {ε}_{e l}^{*} ≪ ε ≪ {ε}_{d} \qquad ( 15 )$$

As for the parameter a, it can be found from the following correlation:

$${d}_{d} = {{d}_{o} ( 1 + ε )}^{a} for ε = {ε}_{d} \qquad ( 16 )$$

in which dₒ is the average cell size at 0% strain and d_{d} is the average diameter of the cells in the densified regime.

From the above equations, the permeability k_{T} of the 1W-SMP open cell foam can be determined after it is compression programmed to a certain strain ε.

In the case that pressurized extrusion is needed to pour the hot or cold 2W-SMP or 2W-SMP modified composite into the interconnected pores in the compression programmed 1W-SMP skeleton, the following equation can be used to estimate the pressure:

$$\frac{Δ p}{d} = \frac{ϑ}{{k}_{T}} U + \frac{ρ}{{B}_{T}} {U}^{2} \qquad ( 17 )$$

where Δp is the difference between the pressure on the top and at the bottom of the foam skeleton (if we assume the bottom pressure is zero, then Δp becomes the pressure on the top of the sealant stripe to extrude the 2W-SMP into the interconnected pores within the compression programmed 1W-SMP skeleton), d is the depth of the 1W-SMP skeleton, θ is the dynamic viscosity of the liquid 2W-SMP, ρ is the density of the 2W-SMP, k_{T} is the permeability of the foam, B_{T} is the inertial flow coefficient of the foam, and U is the flow velocity of the 2W-SMP liquid. For laminar flow (when U is small), the second term on the righthand side in Eq. (17) can be neglected [24].

### Example 3

### Proof-of-Concept Studies

### Case I

To prove the concept of the hybrid smart sealant, we prepared a honeycomb cellular sample made of silicone rubber. FIG. 12A shows the honeycomb sample. The specimen is square shaped with side length of 43.6 mm. The thickness of the sample is 15.4 mm. The porosity is 50%. As shown in FIG. 12B, a 2W-SMP is filled in the empty space between the hexagon columns, forming an interconnected 2W-SMP filler.

To prepare the 2W-SMP, 50 g of cis poly(1,4-butadiene) (PBD) was cut into small pieces and added into a 1000 ml conical flask. 950 g of chloroform was then added to the flask. The flask was fully covered and placed in a hood at room temperature for 4 days to achieve swelling and dissolution of the PBD. The mixture was then mechanically stirred for 1 h to obtain homogeneous PBD solution. 200 g of plasticizer bis(2-ethylhexyl) Sebacate, and 7.5 g of Dicumyl peroxide as hardener were added to the PBD solution. The mixture was stirred for 30 min and then poured into an aluminum dish to evaporate the chloroform. After placing in a hood for 1 day at room temperature, the sample was transferred to a vacuum oven at room temperature for 24 hours to completely remove the chloroform. The as-prepared PBD-80 wt % plasticizer was then cured at 130° C. for 30 min. The silicone rubber mold filled in with the 2W-SMP was cured under the same conditions.

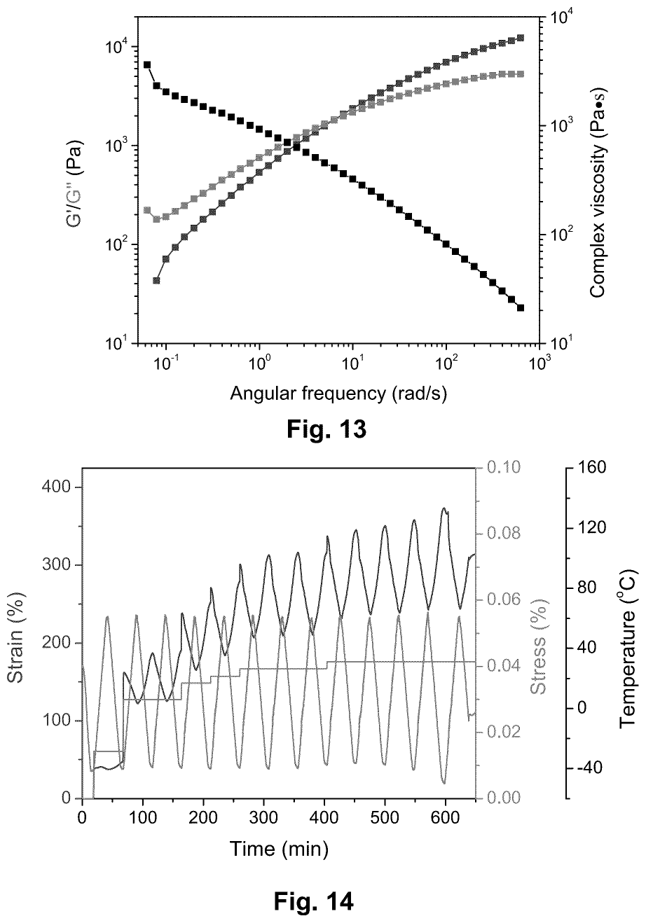

Before curing the PBD solution, the rheological properties of the solution were tested by a rheometer to determine its extrusion ability in situ. The test results are shown in FIG. 13. From FIG. 13, it is seen that the uncured 2W-SMP exhibits a shear thinning properties, i.e., the viscosity decreases as the shear speed increases, which allows for a material to be extruded. In other words, the uncured 2W-SMP can be poured/extruded into the cellular skeleton in situ. FIG. 12b shows the uncured 2W-SMP poured into the silicone honeycomb mold.

After curing, the two-way shape memory effect (2W-SME) of the 2W-SMP was evaluated by a dynamic mechanical analysis (DMA) machine Q-800 (TA instruments, DE, USA). The test results are shown in FIG. 14. From FIG. 14, it is seen that the 2W-SMP demonstrates an excellent 2W-SME with over 100% expansion upon cooling and over 100% contraction upon heating, within a temperature range of −40° C. to 60° C. The temperature spans 100° C. and covers from hot to cold regions, suggesting that it may work in most geographical regions of this country and globally.

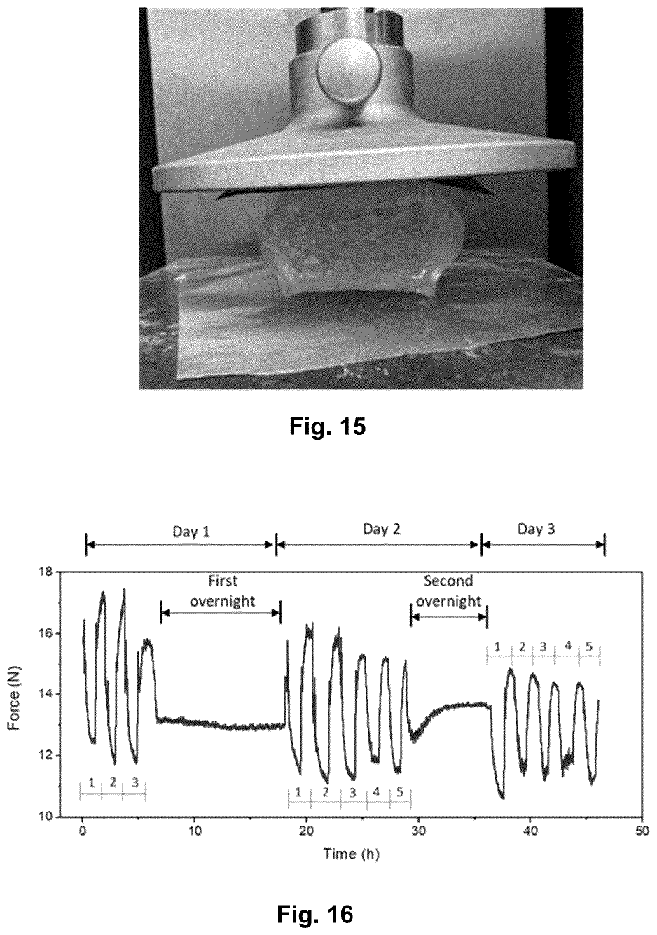

The cured sample was then moved to the Xpert 2610 (ADMET, Norwood, MA, USA) materials testing machine at room temperature. The test was started by compressing the sample to 20% compressive strain, and this strain was maintained during the entire test procedure. FIG. 15 shows that the sample was compressed in the machine.

With the compression to 20% strain, a compressive stress was applied to the sample. It is clear that with temperature dropping, the sample, together with the steel bar which transfers the load from the load cell to the sample, will contract. With the contraction of the system, the applied compressive load will decrease. If the contraction is so large that the compressive load becomes zero, it indicates that the sample loses contact with the testing system, signifying separation of the sealant from the concrete wall in real world applications. Therefore, by monitoring the change of the compressive load with temperature, we can figure out if the sealant separates from the concrete wall or not. Here, we intentionally used a steel bar which has a length of about 1 meter, to simulate the contraction of the concrete slab in pavement. Assuming a coefficient of thermal expansion (CTE) of 16×10⁻⁶/° C. for typical stainless steels, when temperature drops from 60° C. to −40° C., the 1-meter steel bar will contract by 16×10⁻⁶/Cx (60° C.−(−40° C.))×1000 mm=1.6 mm. For the compressed sample with a height of 43.6 mm×(1−20%)=34.88 mm, this translates to a contraction strain of 1.6 mm/34.88 mm=4.6%. In order to keep the 20% constant compressive strain to the sample, the compressive load applied to the sample must be reduced when the steel bar contracts. Therefore, during cooling, the reduction in the compressive load comes from (a) contraction of the sample itself, and (b) the 4.6% contraction of the steel bar. Of course, during heating, both the sample and the steel bar contribute to expansion and thus increase in the compressive load. Therefore, the separation of the sealant sample from the concrete wall is signified when the compressive load becomes zero during cooling.

The entire test lasted about 47 hours. FIG. 16 shows the test results. The test can be divided into three days. On Day 1, the sample was first compressed to 20% compressive strain at room temperature. The temperature was then cooled to −40° C. by using liquid nitrogen (LN₂) in the test chamber. Clearly, with temperature dropping, the compressive stress decreased, due to the contraction of the steel bar and the sample itself. However, even at −40° C., there still existed a large compressive load, indicating that the sample was still in close contact with the clamps of the machine, and no separation occurred. With temperature rising by the embedded heaters in the chamber, both the sample and the steel bar expanded, leading to increases in the compressive load. This cycle of cooling and heating is similar to any conventional elastic or rubber materials. However, the 2W-SMP filled in the honeycomb has experienced a training cycle. In particular, when the compressive load reduces during the cooling branch, the 2W-SMP experienced some tensile stress, which is usually needed to trigger two-way shape memory effect (expansion upon cooling and contraction upon heating). The second cycle starts with cooling from 60° C. to −40° C., followed by heating from −40° C. to 60° C. As compared to the first cooling-heating cycle, it is seen that the compressive load at the lowest temperature is reduced, while the compressive load at the highest temperature is increased. This shows that in the second cycle, the sealant still behaves like a conventional rubber sealant. However, the 2W-SMP within the honeycomb is trained for the second time. In the third cycle, it is seen that the compressive load does not reduce as compared to the second cycle at −40° C., while the compressive load reduces at 60° C., as compared to the second cycle. This shows that during the cooling branch, the 2W-SMP tends to expand, counterbalancing the contraction of the rubber skeleton. As a result, we do not see further reduction in the compressive load as compared to the second cooling branch. In the third heating branch, the 2W-SMP filler contracts, again counterbalancing the expansion of the sealant, leading to reduction in the compressive load at 60° C. This is exactly what we hypothesized. This shows that after two cycles of cooling and heating, the 2W-SMP gel filled in the rubber skeleton starts to take effect. It expands upon cooling and contracts upon heating. As a result, our idea of adhesive-free hybrid sealant works, even at −40° C.

After the three cycles, the sample was cooled down from 60° C. to room temperature, and maintained at 20% compressive strain at room temperature, for overnight. As shown in FIG. 16, for over 10 hours of overnight test, the compressive load remains constant, suggesting no creep or stress relaxation occurs, or in other words, the sealant is quite stable.

On Day 2, we conducted 5 cycles of tests. Similar to Day 1, from the third cycle to the fifth cycle, the compressive load increased at −40° C. but decreased at 60° C. Again, this is a direct indication that after two cycles of training, the 2W-SMP gel filler starts to exhibit its two-way shape memory effect. Instead of separation from the concrete wall, the sealant contacts with the concrete wall even more tightly at the lowest temperature, which once again validates the concept of the present disclosure: an adhesive-free hybrid sealant that works at low temperature regions. This type of phenomenon has never been seen before for sealants because they tend to separate from the concrete wall as temperature drops. After the five cycles, the sample was first cooled down to below room temperature, and then came back to room temperature. After that, it experienced another overnight with 20% compressive strain at room temperature. The initial increase in compressive load is due to the over cooling in the last cooling branch (below the room temperature). The temperature gradually comes back to room temperature. After that, it is seen once again that the compressive load maintains constant, suggesting no creep and no stress relaxation.

On Day 3, we ran five cycles again. This time, the two-way shape memory effect of the gel filler takes effect starting from the second cycle, instead of from the third cycle. This shows that after the several times of training, the 2W-SMP filler becomes more mature and is easier to trigger its two-way shape memory effect.

It is noted that the maximum compressive stress applied to the sample during the 47 hours freezing and thawing was 17.5 N/(15.4 mm×43.6 mm)=0.026 MPa. As compared to most one-way shape memory polymers, their recovery stress is much greater than this value. Therefore, although we used a cellular rubber to prove the concept, it will also work if the cellular rubber is replaced by compression programmed cellular one-way shape memory polymers.

Although a particular blend of 2W-SMP is described here, other 2W-SMPs with different transition temperatures could be used to tune the sealant according to the temperatures in the desired location.

### Example 4

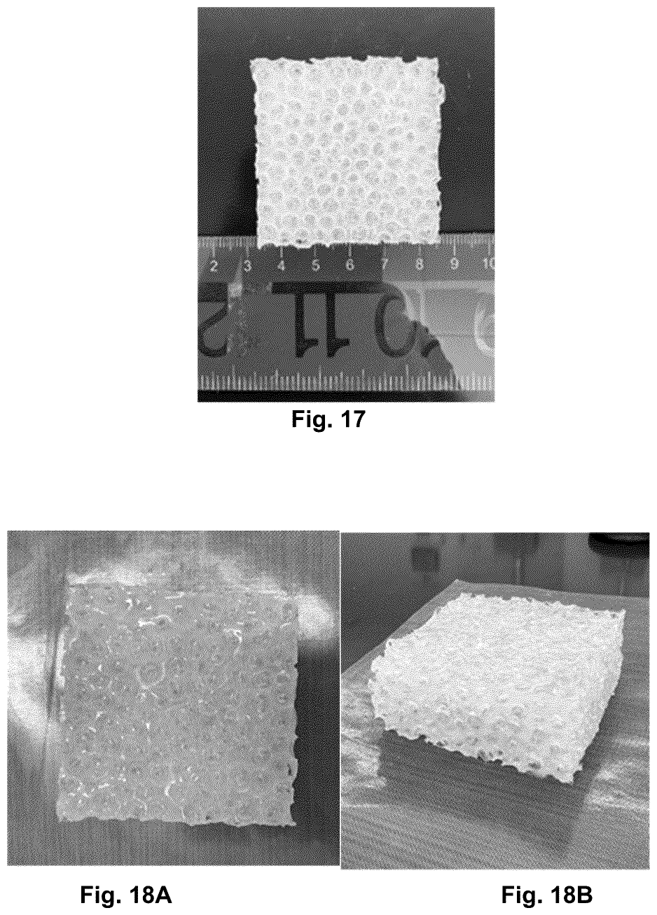

In this case study, we prepared an open cell silicone rubber foam; see FIG. 17. For testing purposes, the foam sample is a square with a side length of 50 mm, and thickness of 25 mm. The pore size is uniform with a diameter of about 2 mm. The open cell foam was then filled in with the same uncured 2W-SMP as described in Example 3. All the procedures were the same as those used in Case I study. The sample was cured at 130° C. for 35 minutes. FIG. 18 shows the silicone open cell foam was filled in with the 2W-SMP gel.

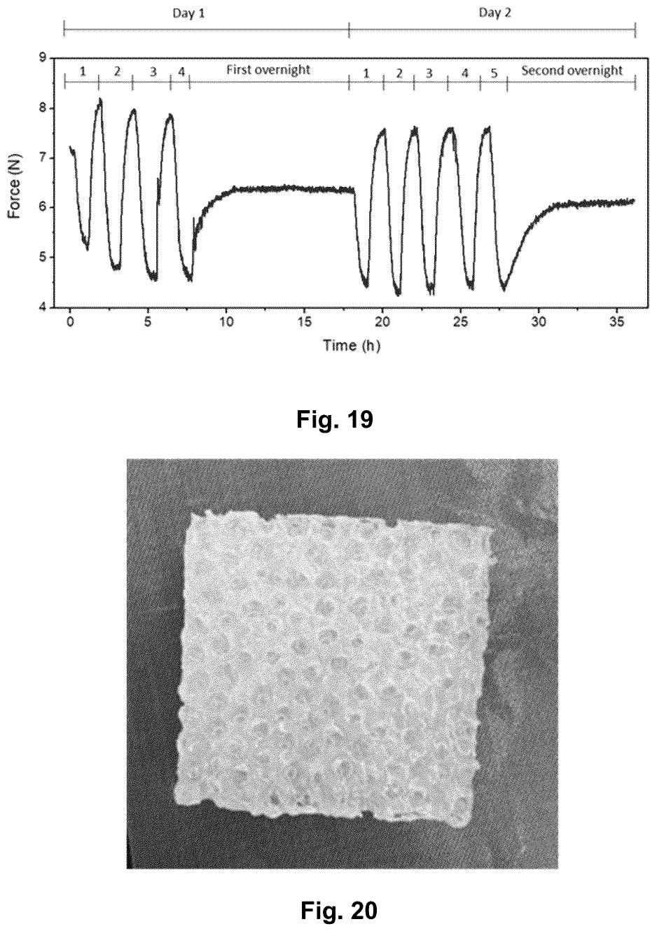

The test lasted for about 37 hours; see results in FIG. 19. On Day 1, we started the test by compressing the sealant sample to 40% strain at room temperature. We then cooled down to −40° C., followed by heating to 60° C., completing the first cycle. As compared with the first cycle, the second cycle shows slightly reduced compressive load at the lowest temperature −40° C. Comparing the third cycle with the second cycle, the compressive load at both the lowest and highest temperature reduces, suggesting that the two-way shape memory effect takes effect in the heating branch, but not in the cooling branch. This is different from the Example 3 study, due to the more complex geometrical structure of the open cell foam. As compared to the cooling branch in cycle 4 with that in cycle 3, it is seen that the compressive load is almost the same, or slightly increased at −40° C., suggesting that the 2W-SMP in the cooling branch takes effect. After the fourth cooling, the sample was gradually warmed up to room temperature, and maintained at room temperature for overnight. Again, no creep and no stress relaxation can be seen during the overnight test, suggesting stability of the sealant sample.

On Day 2, it is seen that from the third cooling, the two-way shape memory effect is activated. The compressive load at the lowest temperature stabilized, or slightly increased, suggesting that the sealant contacts with the concrete wall even more tightly with more cooling/heating cycles. In other words, the concept of hybrid adhesive free sealant is validated.

The sample after the 37 hours of cooling and heating is shown in FIG. 20. Clearly, the sample was undamaged and was in good shape.

It is noted that the maximum stress applied to the sample is 8 N/(25 mm×50 mm)=0.0064 MPa, which is much smaller than the recovery stress provided by a lot of shape memory polymers. Therefore, although the proof-of-concept study was conducted by cellular rubber, it also demonstrates that the concept of using compression programmed one-way shape memory polymer as cellular mold or skeleton is valid. In other words, a hybrid sealant formed from the combination of a porous expandable skeleton filled with a 2W-SMP can behave as an adhesive-free joint sealant under extreme temperatures.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, “about 0” can refer to 0, 0.001, 0.01, or 0.1. In an embodiment, the term “about” can include traditional rounding according to significant figures of the numerical value. In addition, the phrase “about ‘x’ to ‘y’” includes “about ‘x’ to about ‘y’”.

It should be emphasized that the above-described embodiments of the present disclosure are merely possible examples of implementations and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

### REFERENCES

[1] Li, G.; Xu, T., Thermomechanical Characterization of Shape Memory Polymer-Based Self-Healing Syntactic Foam Sealant for Expansion Joints. Journal of Transportation Engineering 2011, 137 (11), 805-814.
[2] Xu, T., and Li, G., A Shape Memory Polymer Based Syntactic Foam with Negative Poisson's Ratio. Materials Science and Engineering A 2011, 528(22-23), 6804-6811.
[3] Xu, T.; Li, G., Cyclic stress-strain behavior of shape memory polymer based syntactic foam programmed by 2-D stress condition. Polymer 2011, 52 (20), 4571-4580.
[4] Xu, T.; Li, G.; Pang, S.-S., Effects of ultraviolet radiation on morphology and thermo-mechanical properties of shape memory polymer based syntactic foam. Composites Part A: Applied Science and Manufacturing 2011, 42 (10), 1525-1533.
[5] Xu, T.; Li, G., Durability of shape memory polymer based syntactic foam under accelerated hydrolytic ageing. Materials Science and Engineering: A 2011, 528 (24), 7444-7450.
[6] Li, G.; King, A.; Xu, T.; Huang, X., Behavior of Thermoset Shape Memory Polymer-Based Syntactic Foam Sealant Trained by Hybrid Two-Stage Programming. Journal of Materials in Civil Engineering 2013, 25 (3), 393-402.
[7] Li, G.; Ji, G.; Meng, H., Shape Memory Polymer-Based Sealant for a Compression Sealed Joint. Journal of Materials in Civil Engineering 2015, 27 (6), 04014196.
[8] Yan, C.; Yang, Q.; and Li, G., A phenomenological constitutive model for semicrystalline two-way shape memory polymers. International Journal of Mechanical Sciences 2020, 177, 105552.
[9] Li, G., Self-Healing Composites: Shape Memory Polymer Based Structures. John Wiley & Sons, Inc., West Sussex, U K, 2014.
[10] Li, G., Liquid Sealant with Thermally Adaptive Properties. U.S. Pat. No. 10,633,541 B2. Apr. 28, 2020.
[11] Lu, L.; Cao, J.; Li, G., A polycaprolactone-based syntactic foam with bidirectional reversible actuation. Journal of Applied Polymer Science 2017, 134 (34), 45225.
[12] Lu, L.; Cao, J.; Li, G., Giant reversible elongation upon cooling and contraction upon heating for a crosslinked cis poly(1,4-butadiene) system at temperatures below zero Celsius. Scientific Reports 2018, 8 (1), 14233.
[13] Ji, G.; Ouyang, Z.; Li, G.; Ibekwe, S. I.; and Pang, S. S., Effects of Adhesive Thickness on Global & Local Mode-I Interfacial Fracture of Bonded Joints. International Journal of Solids and Structures 2010, 47 (18-19), 2445-2458.
[14] Ji, G.; Ouyang, Z.; and Li, G., Effects of Bondline Thickness on Mode-II Interfacial Laws of Bonded Laminated Composite Plate. International Journal of Fracture 2011, 168 (2), 197-207.
[15] Li, G.; Wang, A., Cold, Warm, and Hot Programming of Shape Memory Polymers. Journal of Polymer Science Part B: Polymer Physics 2016, 54, 1319-1339.
[16] Li, G.; Xu, W., Thermomechanical Behavior of Thermoset Shape Memory Polymer Programmed by Cold-Compression: Testing and Constitutive Modeling. Journal of the Mechanics and Physics of Solids 2011, 59 (6), 1231-1250.
[17] Di Prima, M. A.; Lesniewski, M.; Gall, K.; McDowell, D. L.; Sanderson, T.; Campbell, D., Thermo-mechanical behavior of epoxy shape memory polymer foams. Smart Materials and Structures 2007, 16, 2330-2340.
[18] Gibson, J. L.; Ashby, F. M., The mechanics of three-dimensional cellular materials. Proceedings of the Royal Society London A 1982, 382, 43-59.
[19] Fan, J.; and Li, G., High Enthalpy Storage Thermoset Network with Giant Stress and Energy Output in Rubbery State. Nature Communications 2018, 9(1), 642.
[20] Li, A.; Challapalli, A.; and Li, G., 4D Printing of Recyclable Lightweight Architectures Using High Recovery Stress Shape Memory Polymer. Scientific Reports 2019, 9, 7621.
[21] Li, G.; Nettles, D., Thermomechanical Characterization of a Shape Memory Polymer Based Self-Repairing Syntactic Foam. Polymer 2010, 51(3), 755-762.
[22] Li, G.; Uppu, N., Shape Memory Polymer Based Self-Healing Syntactic Foam: 3-D Confined Thermomechanical Characterization. Composites Science and Technology 2010, 70 (9), 1419-1427.
[23] Sarrafan, S.; Li, G., On lightweight shape memory vitrimer composites. ACS Applied Polymer Materials 2024, 6 (1), 154-169.
[24] Dawson, M. A.; Germaine, J. T.; Gibson, L. J., Permeability of open-cell foams under compressive strain. International Journal of Solids and Structures 2007, 44, 5133-5145.

1. A concrete joint and crack sealant, the sealant comprising:
a porous expandable skeleton comprising pores; and
a filler comprising a two-way shape memory polymer (2W-SMP), wherein the filler fills the pores.

2. The sealant according to claim 1, wherein the 2W-SMP is selected from a thermoplastic polymer, a thermoset polymer, a rubber polymer, an elastomer polymer, a semicrystalline polymer, an organic gel polymer, a liquid crystal gel polymer, or an asphalt modified by at least one 2W-SMP.

3. The sealant according to claim 1, wherein the filler further comprises a plasticizer.

4. The sealant according to claim 3, wherein the filler comprises more plasticizer than the 2W-SMP.

5. The sealant according to claim 1, wherein the porous expandable skeleton comprises a one-way shape memory polymer (1W-SMP).

6. The sealant according to claim 5, wherein the 1W-SMP has a glass transition temperature of at least 20° C. higher than the highest temperature that will be encountered in an area in which the sealant is installed.

7. The sealant according to claim 5, wherein the 1W-SMP is selected from a thermoset polymer, a thermoplastic polymer, an elastomer, and a combination of thereof.

8. The sealant according to claim 1, wherein the porous expandable skeleton comprises compressed cellular rubber, cellular elastomeric polymer, cellular semicrystalline polymer, cellular organic gel polymer or cellular liquid crystal polymer.

9. The sealant according to claim 1, wherein the 2W-SMP is selected from a semicrystalline polymer, a thermoset polymer, a thermoplastic polymer, a liquid crystal polymer, an elastomeric polymer, a rubber, an organic gel polymer, and a combination thereof.

10. The sealant according to claim 1, wherein the porous expandable skeleton comprises a hollow center and wherein the filler fills the hollow center.

11. The sealant according to claim 1, wherein the filler comprises cis poly(1,4-butadiene) (PBD) and bis(2-ethylhexyl) Sebacate in a about 1:4 ratio w/w, and wherein the porous expandable skeleton comprises porous silicon rubber.

12. The sealant according to claim 1, wherein the pores of the porous expandable skeleton are interconnected pores.

13. A kit for use in filling concrete joints and cracks, comprising:
a first component and a second component, wherein the first component is to be positioned within a concrete joint or crack and after placement of the first component in concrete joint or crack, the second component is disposed within the first component, wherein forming a concrete joint and crack sealant upon disposing the second component within the first component,
wherein the first component is a porous expandable skeleton comprising pores and the second component is a filler comprising a two-way shape memory polymer (2W-SMP), wherein the filler is used to fill the pores of the porous expandable skeleton.

14. The kit according to claim 13, wherein the 2W-SMP is selected from a thermoplastic polymer, a thermoset polymer, a rubber polymer, an elastomer polymer, a semicrystalline polymer, an organic gel polymer, a liquid crystal polymer, or an asphalt modified by at least one 2W-SMP.

15. The kit according to claim 13, wherein the filler further comprises a plasticizer.

16. The kit according to claim 15, wherein the filler comprises more plasticizer than the 2W-SMP.

17. The kit according to claim 13, wherein the porous expandable skeleton comprises a one-way shape memory polymer (1W-SMP).

18. The kit according to claim 17, wherein the 1W-SMP has a glass transition temperature of at least 20° C. higher than the highest temperature that will be encountered in an area in which the sealant is installed.

19. The kit according to claim 17, wherein the 1W-SMP is selected from a thermoset polymer, a thermoplastic polymer, an elastomer, a semicrystalline polymer, an organic gel polymer, a liquid crystal polymer, and a combination of thereof.

20-24. (canceled)

25. A method for sealing a concrete joint or crack, comprising:
inserting a porous expandable skeleton into the concrete joint or crack; and
filling the skeleton with a filler comprising a two-way shape memory polymer (2W-SMP), wherein the combination of the porous expandable skeleton and the filler form a concrete joint and crack sealant.

26-39. (canceled)
